(19) United States
(12) Patent Application Publication
(10) Pub. No.: US 2026/0099413 A1
(43) Pub. Date: Apr. 9, 2026

(54) APPARATUS FOR FACILITATING TELEMETRY COLLECTION, APPARATUS FOR MANAGING TELEMETRY COLLECTION AND NON-TRANSITORY COMPUTER- READABLE MEDIUM

(71) Applicants: Miraben PATEL, Folsom, CA (US); Sreeja MENON, Delhi (IN); Marcus WINSTON, Aloha, OR (US); Ingrid MURPHY, San Jose, CA (US); Marian CRETU, Santa Clara, CA (US); Kamraan NASIM, Folsom, CA (US); Pawan CHHABRA, Bangalore (IN); Joaquin ROMERA, San Diego, CA (US); Sean DARDIS, Forest Grove, OR (US); Anthony GIARDINA, Colfax, CA (US); Biju Neerthattil SUDHAKARAN, Bangalore (IN); Pratap PRASAD, Santa Clara, CA (US)

(72) Inventors: Miraben PATEL, Folsom, CA (US); Sreeja MENON, Delhi (IN); Marcus WINSTON, Aloha, OR (US); Ingrid MURPHY, San Jose, CA (US); Marian CRETU, Santa Clara, CA (US); Kamraan NASIM, Folsom, CA (US); Pawan CHHABRA, Bangalore (IN); Joaquin ROMERA, San Diego, CA (US); Sean DARDIS, Forest Grove, OR (US); Anthony GIARDINA, Colfax, CA (US); Biju Neerthattil SUDHAKARAN, Bangalore (IN); Pratap PRASAD, Santa Clara, CA (US)

(21) Appl. No.: 19/403,703

(22) Filed: Nov. 28, 2025

(51) Int. Cl. G06F 11/30

(52) U.S. Cl. CPC G06F 11/3037; G06F 11/3058

(57) ABSTRACT

It is provided an apparatus comprising interface circuitry configured to communicate with one or more memory controllers. The apparatus further comprises machine-readable instructions, and processing circuitry to execute the machine-readable instructions. The machine-readable instructions include instructions to receive a request from a management component to initiate collection of telemetry data from one or more memory devices. The machine-readable instructions further include instructions to, in response to the request, send a command to the one or more memory controllers to cause the at least one memory controller to read the telemetry data from one or more memory devices. The machine-readable instructions further include instructions to receive the telemetry data from the at least one memory controller, to stage the telemetry data, and to send an acknowledgement to the management component.

### BACKGROUND

In computing systems, operational parameters of hardware components may need to be monitored to enable system management decisions. Telemetry data such as temperature, bandwidth utilization, energy consumption, or operating frequency may be collected from devices within the system. For example, telemetry data may be used to adjust system operational parameters to maintain performance, manage thermal conditions, or control power consumption. As computing systems incorporate increasing numbers of devices, the collection of telemetry data may present challenges related to latency and scalability. The latency associated with telemetry collection may be particularly important for time-critical management tasks where rapid response may be required. There may be a need for improved approaches to collecting telemetry.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus for facilitating telemetry collection;

FIG. 2 illustrates a flowchart of an example of a method for facilitating telemetry collection;

FIG. 3 illustrates a block diagram of an example of an apparatus for managing telemetry collection;

FIG. 4 illustrates a block diagram of an example of a non-transitory computer-readable medium;

FIG. 5 illustrates a flowchart of an example of a method for managing telemetry collection;

FIG. 6 illustrates an example of a system for facilitating and managing telemetry data collection; and

FIG. 7 illustrates an example of a block diagram of an electronic apparatus incorporating at least one electronic assembly.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

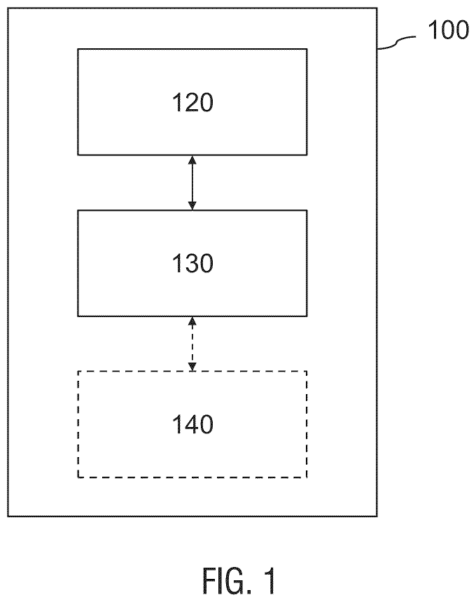

FIG. 1 illustrates a block diagram of an example of an apparatus 100 for facilitating telemetry collection. The apparatus 100 comprises circuitry that is configured to provide the functionality of the apparatus 100. For example, the apparatus 100 of FIG. 1 comprises interface circuitry 120, processing circuitry 130 and storage circuitry 140. For example, the processing circuitry 130 may be coupled with the interface circuitry 120 and with the storage circuitry 140.

For example, the processing circuitry 130 may be configured to provide the functionality of the apparatus 100, in conjunction with the interface circuitry 120. For example, the interface circuitry 120 is configured to exchange information with one or more memory controllers. For example, the storage circuitry 140 is configured to stage telemetry data. Likewise, the apparatus 100 may comprise means that is/are configured to provide the functionality of the apparatus 100.

The components of the apparatus 100 are defined as component means, which may correspond to, or be implemented by, the respective structural components of the apparatus 100. For example, the apparatus 100 of FIG. 1 comprises means for processing 130, which may correspond to or be implemented by the processing circuitry 130, means for communicating 120, which may correspond to or be implemented by the interface circuitry 120, and means for storing information 140, which may correspond to or be implemented by the storage circuitry 140. In the following, the functionality of the apparatus 100 is illustrated with respect to the apparatus 100. Features described in connection with the apparatus 100 may thus likewise be applied to the corresponding apparatus 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 may comprise the machine-readable instructions, for example, within the storage circuitry 140 or means for storing information 140.

For example, the storage circuitry 140 or means for storing information 140 may comprise at least one element of the group of a computer readable storage medium, such as a magnetic or optical storage medium, a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), one or more registers, or a network storage.

In some examples, the apparatus 100 may be integrated within a System-on-Chip (SoC). The SoC may comprise various processing and control components. The apparatus 100 may serve as a telemetry collection agent within the SoC. The apparatus 100 may be configured to interface with one or more memory controllers. The one or more memory controllers may be part of the SoC or may be connected to the SoC. The one or more memory controllers may manage a plurality of memory devices. In some examples, the apparatus 100 may be part of a computing platform. The computing platform may comprise the SoC, the plurality of memory devices, memory modules, a motherboard, and/or additional platform components. The apparatus 100 may facilitate collection of telemetry data from the plurality of memory devices. The platform controller may be located externally to the SoC on the computing platform. In some examples, the computing platform may be a graphics processing unit (GPU) device. In some examples, the computing platform may be a server system. In some examples, the computing platform may be a datacenter system. In some examples, the computing platform may be any system requiring collection of telemetry data from multiple memory devices.

The telemetry data may be used for management and control of the computing platform. In some examples, the apparatus 100 may interface with a management component. The management component may be configured to manage operational aspects of the computing platform. The management component may comprise firmware executing on processing circuitry within the SoC. In some examples, the management component may comprise a platform controller. In some examples, the apparatus 100 may operate as an intermediary between the management component and the one or more memory controllers. The apparatus 100 may provide a uniform interface to the management component. The uniform interface may abstract memory controller-specific implementation details.

For example, the interface circuitry 120 or means for communicating 120 may correspond to one or more inputs and/or outputs for receiving and/or transmitting information with the one or more memory controllers. The information may be in digital values according to a specified code. The interface circuitry 120 or means for communicating 120 may enable communication within a module, between modules, or between modules of different entities. For example, the interface circuitry 120 or means for communicating 120 may comprise circuitry configured to receive and/or transmit information.

The interface circuitry is configured to communicate with one or more memory controllers. In some examples, the memory controller may be a component, for example a hardware component, configured to manage access to one or more memory devices. The memory controller may control read and write operations to the one or more memory devices. The memory controller may manage data flow between the one or more memory devices and other components of the computing platform. The memory controller may be configured to collect telemetry data from the one or more memory devices. The telemetry data may comprise temperature data, bandwidth data, energy consumption data, or operating frequency data from the one or more memory devices. The one or more memory controllers may be integrated within the SoC. In some examples, the one or more memory controllers may be separate components connected to the SoC. Each memory controller of the one or more memory controllers may manage a subset of the plurality of memory devices. In some examples, a single memory controller may manage all of the plurality of memory devices.

In some examples, the processing circuitry 130 may be configured to provide a uniform interface to the management component. The uniform interface may abstract differences between the one or more memory controllers. The processing circuitry 130 may handle memory controller-specific variations internally. The management component may interact with the apparatus 100 through a consistent interface regardless of the underlying memory controller configurations.

In some examples, the processing circuitry 130 may be configured to translate requests from the management component into memory controller-specific formats. The management component may send a standardized request to the apparatus 100. The processing circuitry 130 may convert the standardized request into a command format required by a specific memory controller. Different memory controllers may require different command formats. The processing circuitry 130 may maintain configuration information for each memory controller. The processing circuitry 130 may select the appropriate command format based on the target memory controller.

In some examples, the processing circuitry 130 may be configured to normalize telemetry data received from different memory controllers. Different memory controllers may provide telemetry data in different formats. Different memory controllers may use different data structures. Different memory controllers may use different units of measurement. The processing circuitry 130 may convert the telemetry data from different memory controllers into a uniform format. The processing circuitry 130 may store the normalized telemetry data in the storage circuitry 140 according to a predefined layout.

In some examples, the uniform interface may be a logical abstraction provided by the processing circuitry 130. The uniform interface may define a standardized set of commands, registers, and protocols. The management component may interact with the apparatus 100 through the uniform interface. The processing circuitry 130 may implement the uniform interface by executing machine-readable instructions. The uniform interface may utilize the interface circuitry 120 for actual signal transmission. The interface circuitry 120 may carry the physical communication while the uniform interface defines the logical structure of that communication.

In some examples, the uniform interface may comprise a standardized register map. The register map may define a set of register addresses accessible by the management component. The register addresses may have consistent meanings regardless of which memory controllers are present in the computing platform. The processing circuitry 130 may map the standardized register addresses to corresponding locations in different memory controllers. In some examples, the uniform interface may comprise a standardized command set. The management component may issue commands using the standardized command set. The standardized command set may be independent of the specific memory controller implementations. The processing circuitry 130 may translate commands from the standardized command set into memory controller-specific operations.

In some examples, the uniform interface may enable portability across different computing platforms. A first computing platform may comprise a first set of memory controllers. A second computing platform may comprise a second set of memory controllers. The first set of memory controllers may differ from the second set of memory controllers in manufacturer, protocol, or capability. The management component may use identical commands and register accesses for both the first computing platform and the second computing platform. The apparatus 100 may handle the differences between the first set of memory controllers and the second set of memory controllers internally. The uniform interface may reduce maintenance effort. The management component may not require modification when memory controller configurations change. Firmware of the management component may remain consistent across different computing platforms.

Further, the apparatus comprises the processing circuitry 130. For example, the processing circuitry 130 or means for processing 130 may be implemented using one or more processing units, one or more processing devices, any means for processing, such as a processor, a computer, a programmable hardware component being operable with accordingly adapted software, a sequencer circuitry, or a finite state machine. In other words, the described function of the processing circuitry 130 or means for processing 130 may be implemented in software, which is then executed on one or more programmable hardware components. For example, the described function of the processing circuitry 130 or means for processing 130 may be implemented in dedicated hardware logic, such as a sequencer circuitry or a finite state machine, which is configured to perform a predetermined sequence of operations. Such hardware components may comprise a general-purpose processor, a Digital Signal Processor (DSP), a micro-controller, a sequencer circuitry, or a finite state machine.

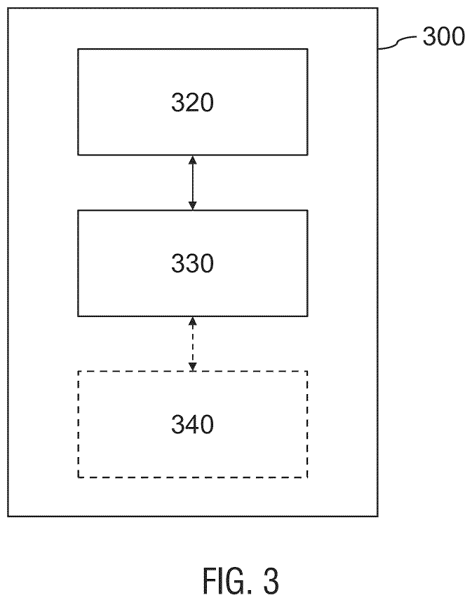

The processing circuitry 130 is configured to receive a request from a management component to initiate collection of telemetry data from one or more memory devices of a plurality of memory devices managed by the one or more memory controllers. The management component (see for example apparatus 300 in FIG. 3) may be responsible for managing operational aspects of the computing platform. The operational aspects may comprise thermal management, performance management, or power management.

The management component may be responsible for managing operational aspects of the computing platform. The operational aspects may comprise thermal management, performance management, or power management. In some examples, the management component may be a component configured to manage one or more operational aspects of the computing platform. For example, the computing platform may comprise the apparatus 100. The management component may monitor operational parameters of the computing platform. The management component may adjust system settings based on the operational parameters. The management component may ensure the computing platform operates within specified limits.

In some examples, the one or more operational aspects may comprise thermal management. Thermal management may involve monitoring temperature of components. Thermal management may involve adjusting operating parameters to control temperature. The one or more operational aspects may comprise performance management. Performance management may involve monitoring workload and resource utilization. Performance management may involve adjusting clock frequencies or power states. The one or more operational aspects may comprise power management. Power management may involve controlling energy consumption. Power management may involve transitioning components between power states.

In some examples, the management component may utilize the telemetry data collected by the apparatus 100. The telemetry data may provide information about the operational state of the plurality of memory devices. The management component may make decisions based on the telemetry data. The management component may adjust operational parameters in response to the telemetry data. The management component may trigger protective actions if the telemetry data indicates critical conditions. In some examples, the management component may comprise firmware. The firmware may be executed by processing circuitry on the SoC. The SoC may also comprise the apparatus 100. The firmware may be stored in a memory within the SoC. The firmware may run continuously to perform management functions. The firmware may be part of a power management subsystem of the SoC. The firmware may communicate with the apparatus 100 through internal SoC interconnects. The communication may occur without leaving the SoC package.

In some examples, the management component may comprise a platform controller. The platform controller may be a separate hardware component. The platform controller may be disposed on the computing platform externally to the SoC. The platform controller may be located on a motherboard of the computing platform. The platform controller may be a baseboard management controller. The platform controller may be a platform management controller. The platform controller may have dedicated processing circuitry for management tasks. The platform controller may communicate with the apparatus 100 through an inter-chip interface. The inter-chip interface may be a bus interface or a point-to-point interface.

In some examples, the management component may interact with the apparatus 100 through the interface circuitry 120. Whether the management component is firmware within the SoC or a platform controller external to the SoC, the interaction may follow the same protocol. The apparatus 100 may provide the same interface circuitry 120 to both types of management components. The management component may send requests to the apparatus 100. The management component may receive acknowledgements from the apparatus 100. The management component may retrieve telemetry data from the apparatus 100.

In some examples, the request may be a command transmitted to the processing circuitry 130. The request may be transmitted via the interface circuitry 120. The request may comprise a data structure containing command parameters. The command parameters may specify which telemetry data to collect. The command parameters may specify from which memory devices of the plurality of memory devices to collect telemetry data. The request may be formatted according to the uniform interface provided by the apparatus 100. The request may be an internal communication within the SoC. In some examples, the request may originate from a platform controller external to the SoC. For example, the platform controller may communicate with the apparatus 100 through an inter-chip communication interface. The apparatus 100 may handle requests from internal firmware and external platform controllers in the same manner through the uniform interface.

In some examples, the request may instruct the processing circuitry 130 to initiate collection of telemetry data. The collection may involve retrieving telemetry data from one or more memory devices of the plurality of memory devices. The plurality of memory devices may be managed by the one or more memory controllers. The processing circuitry 130 may coordinate with the one or more memory controllers to perform the collection. The one or more memory controllers may access the telemetry data from the respective memory devices they manage.

In some examples, the request may specify collection from a subset of the plurality of memory devices. The subset may comprise one or more memory devices. The subset may comprise all of the plurality of memory devices. The subset may comprise fewer than all of the plurality of memory devices. The processing circuitry 130 may determine which memory devices are included in the subset. In some examples, the request may explicitly identify the subset. The request may contain a list of memory device identifiers. The request may contain address ranges corresponding to specific memory devices. The request may contain a bitmask indicating which memory devices to include. The processing circuitry 130 may extract the subset information from the request parameters.

In some examples, the processing circuitry 130 may determine the subset based on an operational status of each memory device of the plurality of memory devices. The operational status may indicate whether a memory device is currently operational. The operational status may indicate whether a memory device is accessible. The operational status may indicate a power state of the memory device. The processing circuitry 130 may evaluate the operational status before including a memory device in the subset. In some examples, memory devices that are disabled may be excluded from the subset. A disabled memory device may be a memory device that has been deactivated by the computing platform. A disabled memory device may not respond to access attempts. A disabled memory device may not provide valid telemetry data. The processing circuitry 130 may check a disabled status flag for each memory device. Memory devices with the disabled status flag set may be automatically excluded from telemetry collection.

In some examples, memory devices that are in a low-power state may be excluded from the subset. A low-power state may be a state where the memory device has reduced functionality. A memory device in a low-power state may not be able to provide telemetry data. Accessing a memory device in a low-power state may require a wake-up sequence. The wake-up sequence may introduce unacceptable latency. The processing circuitry 130 may exclude such memory devices to avoid latency penalties. In some examples, memory devices that are not accessible may be excluded from the subset. A memory device may not be accessible due to a hardware fault. A memory device may not be accessible due to a configuration error. A memory device may not be accessible because the corresponding memory controller is offline. The processing circuitry 130 may attempt to verify accessibility before including a memory device in the subset. Memory devices that fail the accessibility check may be excluded.

In some examples, the processing circuitry 130 may maintain status information for each memory device of the plurality of memory devices. The status information may be stored in the storage circuitry 140. The status information may comprise an operational status indicator for each memory device. The status information may comprise a power state indicator for each memory device. The status information may comprise an accessibility indicator for each memory device. The status information may be updated periodically. The status information may be updated when the operational state of a memory device changes. The processing circuitry 130 may consult the status information when determining the subset of memory devices for telemetry collection.

In some examples, excluding disabled or inaccessible memory devices may improve efficiency. Attempting to collect telemetry from disabled memory devices may result in errors. Attempting to collect telemetry from disabled memory devices may introduce delays. The processing circuitry 130 may reduce latency by collecting telemetry only from operational memory devices. The processing circuitry 130 may provide more reliable telemetry data by focusing on accessible memory devices.

In some examples, telemetry data may be operational data collected from the one or more memory devices. The telemetry data may provide information about the operational state of the memory devices. The telemetry data may be used for monitoring and management purposes. The telemetry data may enable the management component to make decisions regarding system operation.

In some examples, the telemetry data may comprise temperature data. The temperature data may indicate a temperature of one or more memory devices of the plurality of memory devices. The temperature data may be measured by temperature sensors within the memory devices. The temperature data may be provided in degrees Celsius or degrees Fahrenheit. The temperature data may be used for thermal management of the computing platform. The management component may use the temperature data to prevent overheating. The management component may adjust operating parameters if the temperature data exceeds defined thermal limits.

In some examples, the telemetry data may comprise memory bandwidth data. The memory bandwidth data may indicate a data transfer rate of one or more memory devices. The memory bandwidth data may indicate how much data is being read from or written to the memory devices. The memory bandwidth data may be measured in gigabytes per second or megabytes per second. The memory bandwidth data may indicate utilization of the memory devices. The management component may use the memory bandwidth data for performance optimization. The management component may balance workloads based on the memory bandwidth data.

In some examples, the telemetry data may comprise energy consumption data. The energy consumption data may indicate power consumed by one or more memory devices. The energy consumption data may be measured in watts or milliwatts. The energy consumption data may indicate energy usage over a time period. The energy consumption data may be measured in joules or watt-hours. The management component may use the energy consumption data for power management. The management component may adjust power states or operating voltages based on the energy consumption data. The management component may enforce power budgets using the energy consumption data.

In some examples, the telemetry data may comprise operating frequency data. The operating frequency data may indicate a clock frequency at which one or more memory devices are operating. The operating frequency data may be measured in megahertz or gigahertz. The operating frequency data may indicate a data rate of the memory interface. The management component may use the operating frequency data for performance tuning. The management component may adjust the operating frequency based on workload requirements.

In some examples, the telemetry data may comprise multiple types of data, such as a combination of the telemetry data as mentioned above. For example, the telemetry data may comprise temperature data and memory bandwidth data. The telemetry data may comprise temperature data and energy consumption data. The telemetry data may comprise all of temperature data, memory bandwidth data, energy consumption data, and operating frequency data. The apparatus 100 may collect different types of telemetry data in response to different requests. The apparatus 100 may collect different types of telemetry data simultaneously.

In some examples, the request from the management component may be received on a periodic basis. The management component may send the request at regular time intervals. The time intervals may define how frequently telemetry data is collected. The periodic reception of requests may enable continuous monitoring of the plurality of memory devices. In some examples, the time intervals may be in a range of one millisecond to two milliseconds. The time intervals may be approximately one millisecond. The time intervals may be approximately two milliseconds. The specific time interval may be configured based on system requirements. The specific time interval may depend on how quickly the management component needs updated telemetry data.

In some examples, the periodic basis may provide regular updates of telemetry data to the management component. The management component may receive fresh telemetry data at each interval. The management component may track changes in telemetry data over time. The management component may detect trends in temperature or other telemetry parameters. The periodic collection may enable the management component to respond to changes in operational conditions.

In some examples, the periodic requests may be generated by a timer in the management component. The timer may trigger sending of the request at each time interval. The timer may be a hardware timer or a software timer. The management component may use the timer to maintain a consistent collection schedule. The consistent collection schedule may ensure telemetry data is available when needed for management decisions.

In some examples, the periodic collection may be critical for thermal management. Temperature of memory devices may change rapidly under varying workloads. The management component may need to detect temperature increases quickly. A thermal event may require response within nanoseconds to microseconds. The periodic collection with short time intervals may ensure the management component has sufficiently recent temperature data. The management component may be able to initiate protective actions before critical temperature thresholds are exceeded.

In some examples, the periodic basis may support quality of service requirements. The computing platform may have defined latency requirements for telemetry availability. For example, the periodic collection may ensure telemetry data freshness meets these requirements. The management component may rely on the periodic updates for time-critical decisions. The periodic basis may prevent excessive delays in detecting critical conditions.

The periodic collection may enable a predictable system behavior. The apparatus 100 may process requests at known intervals. The management component may schedule other tasks around the periodic telemetry collection. The periodic approach may avoid conflicts between telemetry collection and other system operations.

The processing circuitry 130 is further configured to, in response to the request, send a command to at least one of the one or more memory controllers to cause the at least one memory controller to read the telemetry data from one or more memory devices. The command may instruct the at least one memory controller to read the telemetry data from one or more memory devices. The one or more memory devices may be managed by the at least one memory controller. In some examples, the command may be a data structure formatted according to a protocol used by the at least one memory controller. The command may comprise a command opcode. The command opcode may identify the type of operation to be performed. The command may comprise parameters. The parameters may identify which telemetry data to read. The parameters may identify from which memory devices to read the telemetry data. The parameters may specify memory device addresses or identifiers. The command may be transmitted via the interface circuitry 120 to the at least one memory controller.

In some examples, different memory controllers may use different command formats. A first memory controller may require a first command format. A second memory controller may require a second command format. The first command format may differ from the second command format in structure, encoding, or protocol. The first memory controller may use a first communication protocol. The second memory controller may use a second communication protocol. The processing circuitry 130 may be configured to generate commands in the appropriate format for each memory controller.

In some examples, the processing circuitry 130 may translate the request from the management component into memory controller-specific commands. The request from the management component may be formatted according to the uniform interface. The uniform interface may use a standardized format. The standardized format may be independent of specific memory controller implementations. The processing circuitry 130 may receive the request in the standardized format. The processing circuitry 130 may determine which memory controllers need to be accessed to fulfill the request. The processing circuitry 130 may identify the subset of memory devices from which telemetry data should be collected. The processing circuitry 130 may determine which memory controller manages each memory device in the subset.

In some examples, the processing circuitry 130 may generate one or more commands based on the determination. If all memory devices in the subset are managed by a single memory controller, the processing circuitry 130 may generate a single command. The single command may be sent to that memory controller. If the memory devices in the subset are managed by multiple memory controllers, the processing circuitry 130 may generate multiple commands. Each command may be directed to a respective memory controller. Each command may specify which memory devices managed by that respective memory controller should provide telemetry data.

In some examples, the processing circuitry 130 may maintain configuration information for each memory controller. The configuration information may specify the command format required by each memory controller. The configuration information may specify the communication protocol used by each memory controller. The configuration information may specify which memory devices are managed by each memory controller. The processing circuitry 130 may consult the configuration information when generating commands. The processing circuitry 130 may select the appropriate command format based on the configuration information.

In some examples, the command may cause the at least one memory controller to initiate a read operation. The read operation may access telemetry sensors within the one or more memory devices. The telemetry sensors may be temperature sensors, bandwidth monitors, power monitors, or frequency counters. The at least one memory controller may send read requests to the one or more memory devices. The one or more memory devices may respond with the telemetry data. The at least one memory controller may receive the telemetry data from the one or more memory devices. The at least one memory controller may store the telemetry data in internal registers.

In some examples, sending multiple commands to multiple memory controllers may occur sequentially. The processing circuitry 130 may send a first command to a first memory controller. The processing circuitry 130 may then send a second command to a second memory controller. In some examples, sending multiple commands may occur in parallel. The processing circuitry 130 may send commands to multiple memory controllers simultaneously. Parallel sending may reduce overall latency for telemetry collection.

For example, the translation performed by the processing circuitry 130 may enable an abstraction of complexity. The management component may use a single standardized request format. The management component may not need to know the specific protocols of individual memory controllers. The management component may not need to know which memory devices are managed by which memory controllers. The processing circuitry 130 may handle all memory controller-specific details. This abstraction may simplify the firmware of the management component. This abstraction may enable the management component to operate across different computing platforms with different memory controller configurations.

The processing circuitry 130 is further configured to receive the telemetry data from the at least one memory controller. The at least one memory controller may collect the telemetry data in response to the command sent by the processing circuitry 130. The at least one memory controller may initiate read operations to access telemetry sensors within the one or more memory devices. For example, the telemetry sensors may provide temperature data, bandwidth data, energy consumption data, and/or operating frequency data. The at least one memory controller may send read requests to the one or more memory devices over a memory interface. The one or more memory devices may respond with the requested telemetry data. The at least one memory controller may receive the telemetry data from the one or more memory devices. The at least one memory controller may store the received telemetry data in internal registers of the at least one memory controller.

In some examples, the at least one memory controller may transmit the telemetry data to the apparatus 100. The transmission may occur via the interface circuitry 120. The at least one memory controller may send the telemetry data in a format specific to the at least one memory controller. The processing circuitry 130 may receive the telemetry data through the interface circuitry 120. The processing circuitry 130 may extract the telemetry data from the received transmission. In some examples, the at least one memory controller may send an acknowledgement along with the telemetry data. The acknowledgement may indicate that the telemetry collection operation has been completed. The processing circuitry 130 may determine that all requested telemetry data has been received based on the acknowledgement.

The processing circuitry 130 is further configured to stage the telemetry data into local storage of the apparatus. For example, staging may comprise temporarily storing the telemetry data in a predefined location. For example, staging may prepare the telemetry data for subsequent retrieval by the management component. The staging may comprise organizing the telemetry data in a specific format or layout. The staging may comprise copying the telemetry data from a receive buffer to the local storage. The processing circuitry 130 may perform the staging operation after receiving the telemetry data from the at least one memory controller.

In some examples, the local storage may be storage circuitry 140 that is part of the apparatus 100. The local storage may be local in the sense that the local storage is integrated within or directly associated with the apparatus 100. The local storage may be accessible by the processing circuitry 130 without requiring communication through external interfaces. The local storage may comprise one or more registers. The processing circuitry 130 may write the telemetry data into the one or more registers during the staging operation. In some examples, the staged telemetry data may remain in the local storage until retrieved by the management component. The local storage may provide faster access compared to reading directly from the one or more memory controllers. The staging into local storage may enable efficient bulk reading of the telemetry data.

As mentioned above, in some examples, the processing circuitry 130 may comprise a sequencer circuitry. The sequencer circuitry may be a hardware logic component configured to execute a predetermined sequence of operations. The sequencer circuitry may be configured to execute the receiving of the request from the management component. The sequencer circuitry may be configured to execute the sending of the command to the at least one memory controller. The sequencer circuitry may be configured to execute the staging of the telemetry data into the local storage. The sequencer circuitry may step through these operations in a defined order. The sequencer circuitry may transition from one operation to the next based on completion signals or status indicators. The sequencer circuitry may operate as dedicated hardware without requiring software execution. For example, using sequencer circuitry may enable deterministic timing and reduced latency compared to software-based implementations.

The processing circuitry 130 is further configured to send an acknowledgement to the management component indicating that the staged telemetry data is available for a non-blocking bulk read operation by a hardware copy engine. The acknowledgement may be a signal or message indicating completion of a task. The acknowledgement may indicate that the staged telemetry data is available. The staged telemetry data may be the telemetry data that has been organized into the predefined layout within the local storage. The acknowledgement may inform the management component that the telemetry data is ready for retrieval. The processing circuitry 130 may send the acknowledgement after completing the staging operation. The acknowledgement may be transmitted via the interface circuitry 120. The management component may receive the acknowledgement and may then initiate retrieval of the telemetry data. The acknowledgement may enable asynchronous operation between the apparatus 100 and the management component. The management component may perform other tasks after sending the request and wait for the acknowledgement before retrieving the telemetry data.

The non-blocking operation may be an operation that does not require the initiating component to wait for completion. The management component may trigger the hardware copy engine to perform the bulk read operation. After triggering the hardware copy engine, the management component may immediately continue executing other tasks. The management component may not need to wait for the bulk read operation to complete. The hardware copy engine may perform the data transfer independently. The hardware copy engine may operate in parallel with other activities of the management component. The non-blocking nature may free processing resources of the management component for other critical tasks.

In some examples, the bulk read operation may be an operation that reads multiple data items in a single transaction or sequence of transactions. The bulk read operation may read the telemetry data from the contiguous, addressable range of registers in the local storage. The bulk read operation may be more efficient than reading individual registers separately. The hardware copy engine may be a dedicated hardware component configured to perform data transfers.

In some examples, using the non-blocking bulk read operation may enable the management component to not consume processing time waiting for data transfer completion. The management component may execute other critical tasks in parallel with the bulk read operation. This parallel execution may be important for meeting quality of service requirements. The management component may need to respond to time-critical events while telemetry collection is ongoing. The non-blocking approach may reduce overall latency in system management operations. The bulk read operation may be faster than sequential individual register reads. Reading the contiguous, addressable range in bulk may utilize efficient bus transfer mechanisms. The hardware copy engine may operate at hardware speeds without software overhead. For example, offloading the data transfer to the hardware copy engine may reduce firmware complexity. The firmware of the management component may not need to implement detailed register read loops. The firmware may simply trigger the hardware copy engine and receive notification when the transfer completes.

The hardware copy engine may read data from a source address range and write the data to a destination address. For example, the hardware copy engine may be part of the management component. The hardware copy engine may use direct memory access (DMA) techniques. The hardware copy engine may transfer the staged telemetry data from the local storage to a location accessible by the management component. The location accessible by the management component may be a memory region or a set of registers where the management component can retrieve the data.

In some examples, the hardware copy engine may be a scatter-gather finite state machine (FSM). A finite state machine may be a hardware logic circuit that operates by transitioning through a defined set of states. Each state may represent a phase of an operation. The FSM may transition from one state to another based on inputs and internal conditions. A scatter-gather FSM may be a specific type of FSM configured to perform scatter-gather data transfer operations. Scatter-gather operations may involve reading data from multiple source locations and writing the data to multiple destination locations. The scatter-gather FSM may read data from non-contiguous source addresses. The scatter-gather FSM may write data to non-contiguous destination addresses. In some examples, the scatter-gather FSM may also efficiently handle contiguous address ranges. The scatter-gather FSM may use a list of source addresses and destination addresses to perform transfers. The scatter-gather FSM may operate as dedicated hardware without requiring software execution. The scatter-gather FSM may provide deterministic timing and low latency for data transfers. For example, implementing the hardware copy engine as an FSM may improve efficiency. The FSM may perform data transfers at hardware speed without software overhead.

In some examples, the scatter-gather FSM may be configured to copy the staged telemetry data from the one or more registers of the apparatus 100 to a storage location accessible by the management component. The one or more registers may be the registers in the local storage of the apparatus 100. The one or more registers may contain the staged telemetry data organized in the predefined layout. The scatter-gather FSM may read the telemetry data from the contiguous, addressable range of the one or more registers. The storage location accessible by the management component may be a memory location where the management component can retrieve the data. The storage location may be a system memory location. The storage location may be a set of registers in a power management unit. The storage location may be any location that the management component can access through its interface. The scatter-gather FSM may perform the copy operation by reading from the source addresses in the apparatus 100 and writing to the destination addresses in the storage location. The scatter-gather FSM may use a bus interface to perform the reads and writes. The scatter-gather FSM may operate independently once triggered by the management component. The management component may access the telemetry data from the storage location after the scatter-gather FSM completes the copy operation. For example, copying to a storage location accessible by the management component may improve convenience. The management component may access the telemetry data from its own address space without needing to access the apparatus 100 directly for each data retrieval.

The apparatus 100 may significantly reduce latency in telemetry data collection. The hardware scatter-gather FSM may perform bulk reads from the local storage instead of the management component reading individual registers from memory controllers over a sideband fabric. Reading from the apparatus 100 may be faster than reading directly from memory controllers. The apparatus 100 may reduce maintenance effort across different computing platforms. The uniform interface provided by the apparatus 100 may abstract memory controller-specific access topologies. The management component firmware may not require modification when memory configurations or memory controller types change from one project to another. The apparatus 100 may provide improved scalability. The apparatus 100 may easily accommodate increasing or decreasing numbers of memory devices without requiring changes to the management component. The apparatus 100 may simplify firmware development. The management component may use common application programming interfaces to access any type of telemetry data. The non-blocking bulk read operation may enable the management component to perform other tasks while telemetry data is being collected and transferred. The apparatus 100 may enable the computing platform to meet quality of service requirements for time-critical operations. The apparatus 100 may enable faster response to thermal events. Thermal events may require response within nanoseconds to microseconds. The reduced latency may prevent catastrophic shutdowns or component damage. The reduced latency may also prevent unnecessary aggressive throttling that would compromise system performance.

Coming back to the local storage. In some examples, the local storage may comprise one or more registers organized as a contiguous, addressable range to facilitate the non-blocking bulk read operation by the hardware copy engine. In some examples, the apparatus 100 may further comprise the local storage. For example, the local storage may be the storage circuitry 140. The storage circuitry 140 may be integrated within the apparatus 100. The storage circuitry 140 may be physically located on the same chip or in the same hardware module as the processing circuitry 130 and the interface circuitry 120. The local storage may comprise one or more registers. The one or more registers may be hardware registers implemented in the apparatus 100. The one or more registers may be organized as a contiguous, addressable range. Each register may occupy a defined address space. The addresses of the registers may form a sequential range without interruption. The contiguous, addressable range may enable a hardware copy engine to access the registers efficiently. The hardware copy engine may perform a non-blocking bulk read operation from the contiguous, addressable range. The non-blocking bulk read operation may allow the hardware copy engine to read multiple registers in a single transfer sequence. The management component may trigger the bulk read operation and then immediately proceed with other tasks. The hardware copy engine may operate independently to complete the data transfer. The contiguous organization of the registers may eliminate the need for the management component or the hardware copy engine to individually address each register. For example, including the local storage within the apparatus 100 may reduce access latency. The management component may access telemetry data from the local storage faster than accessing data directly from the one or more memory controllers.

In some examples, the processing circuitry 130 may be further configured to translate the request received from the management component into a memory controller-specific command format required by the at least one of the one or more memory controllers. The request from the management component may be formatted according to the uniform interface provided by the apparatus 100. The uniform interface may use a standardized format that is independent of specific memory controller implementations. The memory controller-specific command format may be a command format required by the at least one memory controller. Different memory controllers may require different command formats due to different designs, manufacturers, or specifications. A first memory controller may require commands in a first format with specific field arrangements and encodings. A second memory controller may require commands in a second format with different field arrangements and encodings. The processing circuitry 130 may identify which memory controller needs to be accessed. The processing circuitry 130 may determine the appropriate memory controller-specific command format for that memory controller. The processing circuitry 130 may convert the standardized request into the memory controller-specific command format. The conversion may involve restructuring data fields, changing parameter encodings, adjusting command opcodes, or adding protocol headers. The processing circuitry 130 may maintain configuration data that specifies the command format requirements for each memory controller. The translated command in the memory controller-specific format may then be transmitted to the at least one memory controller.

In some examples, the processing circuitry 130 may be further configured to organize the telemetry data received from the at least one memory controller into a predefined layout within the local storage. The telemetry data received from the at least one memory controller may arrive in a memory controller-specific data layout. The memory controller-specific data layout may be determined by the internal design of the at least one memory controller. Different memory controllers may provide telemetry data with different data layouts. A first memory controller may provide temperature values in degrees Celsius at a first byte offset with a first data type. A second memory controller may provide temperature values in a different unit at a different byte offset with a different data type. The processing circuitry 130 may parse the telemetry data according to the memory controller-specific data layout. The processing circuitry 130 may extract individual telemetry values from the received data structure. The processing circuitry 130 may convert units of measurement if necessary. The processing circuitry 130 may then write the telemetry values into the local storage according to a predefined layout. The predefined layout may specify fixed locations within the local storage for each type of telemetry data. Temperature data may always be stored at a first address range. Bandwidth data may always be stored at a second address range. The predefined layout may use consistent data types and units across all telemetry values.

In some examples, the predefined layout may be independent of the data layout of the at least one memory controller. The predefined layout may remain constant regardless of which memory controllers are present in the computing platform. The management component may access telemetry data at known, fixed addresses within the local storage. The management component may use the same register addresses whether the telemetry data originated from a first memory controller or a second memory controller. The processing circuitry 130 may handle all conversions between memory controller-specific data layouts and the predefined layout internally. For example, the layout independence may provide portability of management component firmware. The management component firmware may operate without modification across different computing platforms with different memory controller configurations. Further, the firmware development may be simplified. Firmware developers may write code against a single, well-defined data layout rather than handling multiple memory controller-specific layouts. The predefined layout may also facilitate the non-blocking bulk read operation. The hardware copy engine may read a fixed address range to obtain all telemetry data without needing knowledge of memory controller specifics.

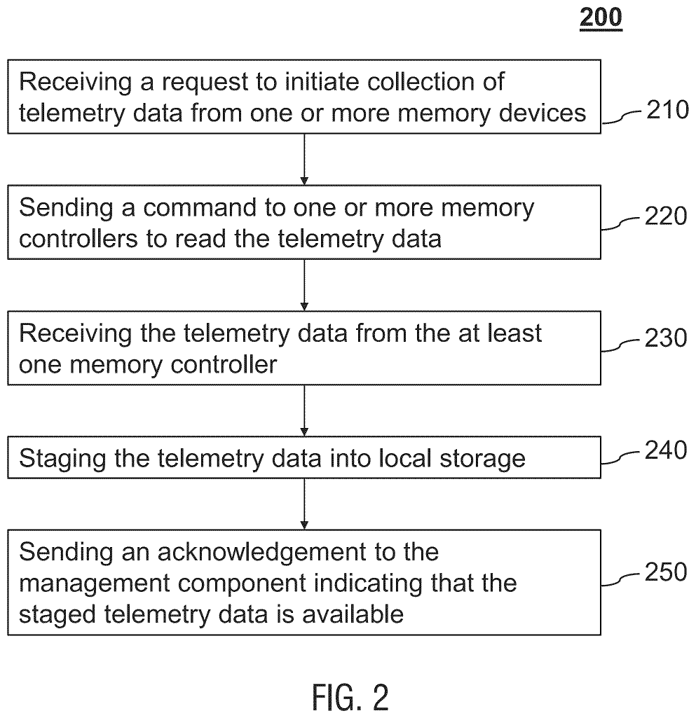

Further details and aspects are mentioned in connection with the examples described below. The example shown in FIG. 1 may include one or more optional additional features corresponding to one or more aspects mentioned in connection with the proposed concept or one or more examples described (e.g., FIGS. 2-7).

FIG. 2 illustrates a flowchart of an example of a method 200 for facilitating telemetry collection 200. The method 200 may, for instance, be performed by an apparatus as described herein, such as apparatus 100. The method 200 comprises receiving 210 a request from a management component to initiate collection of telemetry data from one or more memory devices of a plurality of memory devices managed by one or more memory controllers. The method 200 further comprises, in response to the request, sending 220 a command to at least one of the one or more memory controllers to cause the at least one memory controller to read the telemetry data from one or more memory devices. The method 200 further comprises receiving 230 the telemetry data from the at least one memory controller. The method 200 further comprises staging 240 the telemetry data into local storage. The method 200 further comprises sending 250 an acknowledgement to the management component indicating that the staged telemetry data is available for a non-blocking bulk read operation by a hardware copy engine.

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIGS. 3-7).

FIG. 3 illustrates a block diagram of an example of an apparatus 300 for managing telemetry collection or device 300. For example, the apparatus 300 described with reference to FIG. 3 may incorporate elements, components, and concepts that have been described above with reference to FIG. 1 and the apparatus 100. The terminology, definitions, and technical details established in the preceding descriptions may apply equally to the apparatus 300 unless explicitly stated otherwise. The apparatus 300 may interact with the apparatus 100 to perform telemetry collection operations. The apparatus 300 may send requests to the apparatus 100 and retrieve telemetry data that has been collected and staged by the apparatus 100. The apparatus 300 and the apparatus 100 may together form a telemetry collection system within the computing platform.

The apparatus 300 comprises circuitry that is configured to provide the functionality of the apparatus 300. For example, the apparatus 300 of FIG. 3 comprises interface circuitry 320, processing circuitry 330 and (optional) storage circuitry 340. For example, the processing circuitry 330 may be coupled with the interface circuitry 320 and optionally with the storage circuitry 340.

For example, the processing circuitry 330 may be configured to provide the functionality of the apparatus 300, in conjunction with the interface circuitry 320. For example, the interface circuitry 320 is configured to exchange information, e.g., with other components inside or outside the apparatus 300 and the storage circuitry 340. Likewise, the device 300 may comprise means that is/are configured to provide the functionality of the device 300.

The components of the device 300 are defined as component means, which may correspond to, or implemented by, the respective structural components of the apparatus 300. For example, the device 300 of FIG. 3 comprises means for processing 330, which may correspond to or be implemented by the processing circuitry 330, means for communicating 320, which may correspond to or be implemented by the interface circuitry 320, and (optional) means for storing information 340, which may correspond to or be implemented by the storage circuitry 340. In the following, the functionality of the device 300 is illustrated with respect to the apparatus 300. Features described in connection with the apparatus 300 may thus likewise be applied to the corresponding device 300.

In general, the functionality of the processing circuitry 330 or means for processing 330 may be implemented by the processing circuitry 330 or means for processing 330 executing machine-readable instructions. Accordingly, any feature ascribed to the processing circuitry 330 or means for processing 330 may be defined by one or more instructions of a plurality of machine-readable instructions. The apparatus 300 or device 300 may comprise the machine-readable instructions, e.g., within the storage circuitry 340 or means for storing information 340.

The interface circuitry 320 or means for communicating 320 may correspond to one or more inputs and/or outputs for receiving and/or transmitting information, which may be in digital (bit) values according to a specified code, within a module, between modules or between modules of different entities. For example, the interface circuitry 320 or means for communicating 320 may comprise circuitry configured to receive and/or transmit information.

For example, the processing circuitry 330 or means for processing 330 may be implemented using one or more processing units, one or more processing devices, any means for processing, such as a processor, a computer or a programmable hardware component being operable with accordingly adapted software. In other words, the described function of the processing circuitry 330 or means for processing 330 may as well be implemented in software, which is then executed on one or more programmable hardware components. Such hardware components may comprise a general-purpose processor, a Digital Signal Processor (DSP), a micro-controller, etc.

For example, the storage circuitry 340 or means for storing information 340 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

In some examples, the apparatus 300 may be an apparatus for managing telemetry collection. The apparatus 300 may be a management component configured to manage one or more operational aspects of the computing platform. The computing platform may comprise memory devices from which telemetry data is to be collected. The apparatus 300 may be responsible for initiating collection of telemetry data and utilizing the collected telemetry data for management decisions. The one or more operational aspects may comprise thermal management, performance management, or power management. The apparatus 300 may interface with a telemetry collection agent. The telemetry collection agent may be the apparatus 100 as described with respect to FIG. 1. The interface circuitry 320 may be configured to communicate with the telemetry collection agent. The apparatus 300 may send requests to the telemetry collection agent to initiate telemetry data collection. The apparatus 300 may receive acknowledgements from the telemetry collection agent indicating availability of telemetry data. In some examples, the apparatus 300 may further comprise a hardware copy engine.

The processing circuitry 330 is configured to send a request to a telemetry collection agent to initiate collection of telemetry data from one or more memory devices of a plurality of memory devices managed by one or more memory controllers. In some examples, the telemetry collection agent may be the apparatus 100 as described with reference to FIG. 1. The telemetry collection agent may serve as an intermediary between the apparatus 300 and the one or more memory controllers. The one or more memory controllers may be components, such as hardware components, configured to manage access to the plurality of memory devices. For example, each memory controller of the one or more memory controllers may manage a subset of the plurality of memory devices. In some examples, a single memory controller may manage all of the plurality of memory devices. The one or more memory controllers may be integrated within a SoC or may be separate components connected to the SoC. The request may instruct the telemetry collection agent to begin collecting telemetry data. The request may be transmitted via the interface circuitry 320. The request may be formatted according to a uniform interface provided by the telemetry collection agent. The uniform interface may use a standardized format independent of specific memory controller implementations.

In some examples, the telemetry data may be operational data collected from the one or more memory devices. The telemetry data may provide information about the operational state of the memory devices. The telemetry data may be used by the apparatus 300 for monitoring and management purposes. The telemetry data may enable the apparatus 300 to make decisions regarding system operation. The telemetry data may reflect current operating conditions of the memory devices. The telemetry data may be collected periodically to track changes over time.

In some examples, the telemetry data may comprise temperature data. The temperature data may indicate a temperature of one or more memory devices of the plurality of memory devices. The temperature data may be measured by temperature sensors within the memory devices. The temperature data may be provided in degrees Celsius or degrees Fahrenheit. The apparatus 300 may use the temperature data for thermal management of the computing platform. The apparatus 300 may monitor the temperature data to prevent overheating of memory devices. The apparatus 300 may initiate protective actions if the temperature data exceeds defined thermal limits. In some examples, the telemetry data may comprise memory bandwidth data. The memory bandwidth data may indicate a data transfer rate of one or more memory devices. The memory bandwidth data may indicate how much data is being read from or written to the memory devices. The memory bandwidth data may be measured in gigabytes per second or megabytes per second. The memory bandwidth data may indicate utilization of the memory devices. The apparatus 300 may use the memory bandwidth data for performance optimization. The apparatus 300 may balance workloads based on the memory bandwidth data.

In some examples, the telemetry data may comprise energy consumption data. The energy consumption data may indicate power consumed by one or more memory devices. The energy consumption data may be measured in watts or milliwatts. The energy consumption data may indicate energy usage over a time period. The energy consumption data may be measured in joules or watt-hours. The apparatus 300 may use the energy consumption data for power management. The apparatus 300 may adjust power states or operating voltages based on the energy consumption data. The apparatus 300 may enforce power budgets using the energy consumption data. In some examples, the telemetry data may comprise operating frequency data. The operating frequency data may indicate a clock frequency at which one or more memory devices are operating. The operating frequency data may be measured in megahertz or gigahertz. The operating frequency data may indicate a data rate of the memory interface. The apparatus 300 may use the operating frequency data for performance tuning. The apparatus 300 may adjust the operating frequency based on workload requirements. In some examples, the telemetry data may comprise multiple types of data. The telemetry data may comprise a combination of temperature data, memory bandwidth data, energy consumption data, and operating frequency data. The apparatus 300 may collect different types of telemetry data simultaneously. The apparatus 300 may analyze multiple types of telemetry data together to make comprehensive management decisions.

The processing circuitry 330 is further configured to receive an acknowledgement from the telemetry collection agent indicating that telemetry data has been staged and is available for a non-blocking bulk read operation. The acknowledgement may be a signal or message received from the telemetry collection agent. The acknowledgement may indicate completion of the staging operation. The staging operation may involve the telemetry collection agent organizing the telemetry data into a predefined layout within local storage of the telemetry collection agent. The telemetry collection agent may send the acknowledgement after receiving the telemetry data from the one or more memory controllers and completing the staging into the local storage. The processing circuitry 330 may receive the acknowledgement via the interface circuitry 320. The acknowledgement may inform the apparatus 300 that the telemetry data is ready for retrieval. The acknowledgement may indicate that the staged telemetry data is available for a non-blocking bulk read operation. The bulk read operation may be an operation that reads multiple data items in a single transaction or sequence of transactions. The bulk read operation may be more efficient than reading individual data items separately. The non-blocking bulk read operation may be an operation where the apparatus 300 triggers a hardware copy engine to perform the data transfer independently. The non-blocking nature may allow the processing circuitry 330 to continue executing other tasks without waiting for the data transfer to complete. The hardware copy engine may operate in parallel with other activities of the processing circuitry 330. The acknowledgement may enable asynchronous operation. The processing circuitry 330 may perform other tasks after sending the request and then receive the acknowledgement when the telemetry data is ready.

The processing circuitry 330 is further configured, in response to the acknowledgement, to trigger a hardware copy engine to perform the non-blocking bulk read of the staged telemetry data from the telemetry collection agent. In some examples, triggering the hardware copy engine may involve sending a command or signal to the hardware copy engine. The command may specify the source address range from which to read the telemetry data. The source address range may be the contiguous, addressable range of registers in the local storage of the telemetry collection agent. The command may specify a destination address where the telemetry data should be written. The destination address may be a storage location accessible by the apparatus 300. The processing circuitry 330 may trigger the hardware copy engine by configuring control registers of the hardware copy engine. The control registers may define the data transfer parameters.

In some examples, the hardware copy engine may be a dedicated hardware component configured to perform data transfers. The hardware copy engine may operate independently once triggered. The processing circuitry 330 may trigger the hardware copy engine and then immediately continue with other tasks. The processing circuitry 330 may not need to wait for the bulk read operation to complete. The hardware copy engine may read the staged telemetry data from the telemetry collection agent. The staged telemetry data may be organized in the predefined layout within the local storage of the telemetry collection agent. The hardware copy engine may transfer the telemetry data to a storage location accessible by the apparatus 300. The hardware copy engine may use efficient bus transfer mechanisms. The hardware copy engine may operate at hardware speeds without software overhead.

In some examples, the hardware copy engine may be a dedicated hardware component configured to perform data transfers. In some examples, the hardware copy engine may be part of the apparatus 300. In some examples, the hardware copy engine may be a separate component connected to the apparatus 300. The apparatus 300 may comprise the hardware copy engine integrated within the same hardware module. The hardware copy engine may operate independently once triggered. The processing circuitry 330 may trigger the hardware copy engine and then immediately continue with other tasks. The processing circuitry 330 may not need to wait for the bulk read operation to complete. The hardware copy engine may read the staged telemetry data from the telemetry collection agent. The staged telemetry data may be organized in the predefined layout within the local storage of the telemetry collection agent. The hardware copy engine may transfer the telemetry data to a storage location accessible by the apparatus 300. The hardware copy engine may use efficient bus transfer mechanisms. The hardware copy engine may operate at hardware speeds without software overhead. In some examples, the hardware copy engine may be a scatter-gather finite state machine (FSM). The scatter-gather FSM may be a hardware logic circuit configured to perform scatter-gather data transfer operations. The scatter-gather FSM may operate by transitioning through a defined set of states. Each state may represent a phase of the data transfer operation. The scatter-gather FSM may provide deterministic timing and low latency for data transfers.

In some examples, the hardware copy engine may be configured to perform the non-blocking bulk read operation directly from one or more registers of the telemetry collection agent. The one or more registers may be the registers in the local storage of the telemetry collection agent as described with reference to FIG. 1. The one or more registers may contain the staged telemetry data. The one or more registers may be organized as a contiguous, addressable range. The hardware copy engine may read the telemetry data directly from this contiguous, addressable range. The hardware copy engine may thereby offload a data transfer task that would otherwise be performed by the processing circuitry 330. Without the hardware copy engine, the processing circuitry 330 would need to read the telemetry data from the registers of the telemetry collection agent. The processing circuitry 330 would need to execute read instructions for each register or each data item. The processing circuitry 330 would need to wait for each read operation to complete. This would consume processing time of the processing circuitry 330. This would prevent the processing circuitry 330 from performing other tasks during the data transfer. By offloading the data transfer to the hardware copy engine, the processing circuitry 330 may be freed for other operations. The hardware copy engine may perform the bulk read operation more efficiently than software-based sequential reading. The hardware copy engine may utilize burst read capabilities of the bus interface. For example, offloading the data transfer may reduce latency. Further, the firmware complexity may be reduced. The firmware executed by the processing circuitry 330 may not need to implement detailed register read loops.

The processing circuitry 330 is further configured to receive the telemetry data from the hardware copy engine. The hardware copy engine may complete the non-blocking bulk read operation by transferring the telemetry data from the telemetry collection agent to the destination storage location. The destination storage location may be accessible by the processing circuitry 330. After the hardware copy engine completes the data transfer, the processing circuitry 330 may access the telemetry data from the destination storage location. The processing circuitry 330 may read the telemetry data from the storage circuitry 340. The processing circuitry 330 may read the telemetry data from memory registers where the hardware copy engine has written the data.

In some examples, the hardware copy engine may notify the processing circuitry 330 when the data transfer is complete. The notification may be an interrupt signal. The interrupt signal may cause the processing circuitry 330 to execute an interrupt service routine. The notification may be a status flag in a control register. The processing circuitry 330 may poll a status register of the hardware copy engine to determine when the transfer has completed. The processing circuitry 330 may check the status flag periodically. Upon receiving notification of completion, the processing circuitry 330 may access the telemetry data from the destination storage location. The processing circuitry 330 may then process the telemetry data. The processing circuitry 330 may analyze the telemetry data. The processing circuitry 330 may use the telemetry data for management decisions. The processing circuitry 330 may adjust system operational parameters based on the telemetry data. The processing circuitry 330 may compare the telemetry data to threshold values. The processing circuitry 330 may initiate corrective actions if the telemetry data indicates problematic conditions.

The apparatus 300 may enable efficient coordination of telemetry collection operations by interfacing with the telemetry collection agent through a uniform interface. The apparatus 300 may not require detailed knowledge of specific memory controller implementations or access topologies. The apparatus 300 may use a standardized request format regardless of which memory controllers are present in the computing platform. The apparatus 300 may significantly reduce processing overhead by offloading data transfer tasks to the hardware copy engine. The non-blocking bulk read operation may free the processing circuitry 330 to execute other critical tasks while telemetry data is being transferred. The apparatus 300 may respond more quickly to time-critical events such as thermal violations. The apparatus 300 may meet quality of service requirements by avoiding delays associated with sequential register reading. The apparatus 300 may enable continuous monitoring of memory device telemetry through periodic requests. The apparatus 300 may receive fresh telemetry data at regular intervals to track operational conditions. The apparatus 300 may make informed management decisions based on current telemetry data. The apparatus 300 may adjust system operational parameters in real-time to optimize performance, manage thermal conditions, or control power consumption. The apparatus 300 may prevent catastrophic shutdowns or component damage by detecting and responding to critical conditions quickly. The apparatus 300 may also prevent unnecessary aggressive throttling that would compromise system performance. The apparatus 300 may simplify firmware development by providing a consistent interface for telemetry access across different computing platforms.

In some examples, the processing circuitry 330 may be configured to adjust a system operational parameter based on the received telemetry data. A system operational parameter may be a configurable setting that affects operation of the computing platform. The system operational parameter may control performance characteristics of the computing platform. The system operational parameter may control thermal behavior of components. The system operational parameter may control power consumption. The processing circuitry 330 may analyze the received telemetry data to determine appropriate adjustments. The processing circuitry 330 may compare the telemetry data to threshold values. The threshold values may define safe operating limits for the computing platform. The processing circuitry 330 may compare the telemetry data to target ranges. The target ranges may define optimal operating conditions. If the telemetry data indicates that the computing platform is operating outside of desired limits, the processing circuitry 330 may adjust the system operational parameter. The adjustment may bring the computing platform back within specified limits. The adjustment may optimize performance or efficiency.

In some examples, the processing circuitry 330 may be configured to implement control algorithms to determine appropriate adjustments. The control algorithms may use the telemetry data as feedback. The control algorithms may calculate required changes to system operational parameters based on deviations from target values. The processing circuitry 330 may apply proportional control where adjustments are proportional to the deviation. The processing circuitry 330 may apply integral control to eliminate steady-state errors. The processing circuitry 330 may apply derivative control to respond to rates of change. The processing circuitry 330 may use lookup tables that map telemetry values to corresponding parameter settings. The processing circuitry 330 may use predictive algorithms that anticipate future conditions based on current trends. The processing circuitry 330 may coordinate adjustments across multiple system operational parameters. Adjusting multiple parameters simultaneously may achieve better overall results. The ability to adjust system operational parameters based on telemetry data may enable dynamic optimization of the computing platform.

In some examples, the telemetry data may comprise temperature data. The temperature data may indicate temperatures of one or more memory devices. The system operational parameter may be a thermal management parameter. Thermal management parameters may be parameters that affect heat generation or heat dissipation in the computing platform. The thermal management parameter may comprise a clock frequency. The processing circuitry 330 may reduce the clock frequency if the temperature data indicates excessive temperature. Reducing the clock frequency may reduce power consumption and heat generation. The processing circuitry 330 may increase the clock frequency if the temperature data indicates sufficient thermal margin. The thermal management parameter may comprise a fan speed. The processing circuitry 330 may increase the fan speed if the temperature data indicates rising temperatures. Increasing the fan speed may improve cooling. The processing circuitry 330 may decrease the fan speed if the temperature data indicates low temperatures. Decreasing the fan speed may reduce noise and power consumption. The thermal management parameter may comprise a power budget. The power budget may define a maximum power consumption limit. The processing circuitry 330 may reduce the power budget if the temperature data indicates thermal constraints. Reducing the power budget may limit heat generation.

In some examples, the processing circuitry 330 may implement thermal management policies based on the temperature data. The processing circuitry 330 may define multiple temperature thresholds. A first threshold may trigger a first level of response such as slight clock frequency reduction. A second higher threshold may trigger a more aggressive response such as significant clock frequency reduction combined with increased fan speed. A third critical threshold may trigger protective actions such as severe throttling or shutdown. The processing circuitry 330 may gradually adjust thermal management parameters as temperature changes. The gradual adjustment may avoid abrupt performance changes. The processing circuitry 330 may respond quickly to rapid temperature increases to prevent damage. The thermal management based on temperature data may maintain the computing platform within safe thermal limits while optimizing performance.

In some examples, the telemetry data may comprise memory bandwidth data or energy consumption data. The memory bandwidth data may indicate utilization of memory devices. The energy consumption data may indicate power usage of memory devices. The system operational parameter may be a performance management parameter. Performance management parameters may be parameters that affect computational performance or efficiency. The performance management parameter may comprise a clock frequency. The processing circuitry 330 may increase the clock frequency if the memory bandwidth data indicates high utilization and demand for more performance. The processing circuitry 330 may decrease the clock frequency if the memory bandwidth data indicates low utilization. Decreasing the clock frequency during low utilization may save energy. The processing circuitry 330 may adjust the clock frequency based on energy consumption data to balance performance and power efficiency. The performance management parameter may comprise a power state. Power states may define different levels of power consumption and performance capability. The processing circuitry 330 may transition memory devices to lower power states if the memory bandwidth data indicates periods of inactivity. The processing circuitry 330 may transition memory devices to higher power states when performance is needed.

In some examples, the performance management parameter may comprise a voltage level. The voltage level may be an operating voltage supplied to memory devices or other components. The processing circuitry 330 may adjust the voltage level based on performance requirements and energy consumption data. The processing circuitry 330 may use dynamic voltage and frequency scaling techniques. The processing circuitry 330 may reduce voltage and frequency together during low utilization periods. The processing circuitry 330 may increase voltage and frequency together during high performance demand. The processing circuitry 330 may balance multiple objectives such as maximizing performance, minimizing energy consumption, and maintaining thermal limits. The processing circuitry 330 may use the memory bandwidth data to predict future performance requirements. The processing circuitry 330 may proactively adjust performance management parameters before utilization changes. The performance management based on memory bandwidth data and energy consumption data may optimize the computing platform for varying workload conditions.

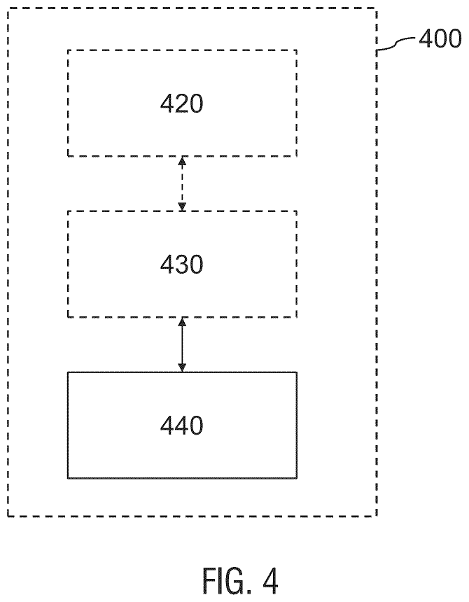

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 4-7).

FIG. 4 illustrates a block diagram of an example of a non-transitory computer-readable medium 440. The non-transitory computer-readable medium 440 stores instructions that, when executed by one or more processing circuitries 430, causes the one or more processing circuitries 430 to perform a method for managing telemetry collection. The one or more processing circuitries 430 may access the non-transitory computer-readable medium 440 via an interface circuitry 420. In some examples, the non-transitory computer-readable medium 440 may be included in an apparatus 400, which may also comprise the one or more processing circuitries 430. In some examples, the one or more processing circuitries 430 may be distributed over a plurality of apparatuses and may for example, access the non-transitory computer-readable medium 440 via the interface circuitry 420.

For example, the non-transitory computer-readable medium may refer to any tangible, physical medium capable of storing instructions, data, or other types of information for access by a computer, processor, or similar electronic device. The computer-readable medium may be non-transitory in that the medium may have a persistent or enduring form. The medium may retain stored information even when power is removed. The non-transitory computer-readable medium may comprise magnetic storage devices. Magnetic storage devices may include hard disk drives (HDDs) and magnetic tapes. Magnetic storage devices may store data using magnetic patterns. Magnetic storage devices may be used for long-term data storage in computers, servers, and backup systems. The non-transitory computer-readable medium may comprise optical storage media. Optical storage media may include compact discs (CDs), digital versatile discs (DVDs), and Blu-ray discs. Optical storage media may utilize laser technology to read and write data. Optical storage media may offer durability and longevity for storing software, media, and backups.

In some examples, the non-transitory computer-readable medium may comprise solid-state devices (SSDs). Solid-state devices may rely on flash memory technology. Solid-state devices may operate without moving parts. Solid-state devices may include USB flash drives, secure digital (SD) cards, or internal and external SSDs. Solid-state devices may provide fast read and write speeds and portability. In some examples, the non-transitory computer-readable medium may comprise non-volatile memory chips. Non-volatile memory chips may include read-only memory (ROM) and programmable ROM (PROM). Non-volatile memory chips may store firmware or embedded software. The non-volatile memory chips may be included in embedded systems and computers. In some examples, the non-transitory computer-readable medium may comprise phase-change memory (PCM). In some examples, the non-transitory computer-readable medium may comprise magnetoresistive RAM (MRAM). In some examples, the non-transitory computer-readable medium may comprise ferroelectric RAM (FeRAM). These memory technologies may offer persistent data storage with high reliability, speed, and power efficiency. These memory technologies may be suitable for applications requiring rapid access and data retention. Such applications may include mobile devices, high-performance computing, and industrial systems.

For example, the one or more processing circuitries 430 may access the non-transitory computer-readable medium 440 over the interface circuitry 420. For example, the one or more processing circuitries 430 may then execute the instructions stored on the non-transitory computer-readable medium 440. The execution of the instructions stored on the non-transitory computer-readable medium 440 causes the one or more processing circuitries 430 to the perform the method for managing telemetry collection.

The method for managing telemetry collection comprises sending a request to a telemetry collection agent to initiate collection of telemetry data from one or more memory devices of a plurality of memory devices managed by one or more memory controllers. The method further comprises receiving an acknowledgement from the telemetry collection agent indicating that telemetry data has been staged and is available for a non-blocking bulk read operation. The method further comprises, in response to the acknowledgement, triggering hardware copy engine to perform the non-blocking bulk read of the staged telemetry data from the telemetry collection agent. The method further comprises receiving the telemetry data from the hardware copy engine.

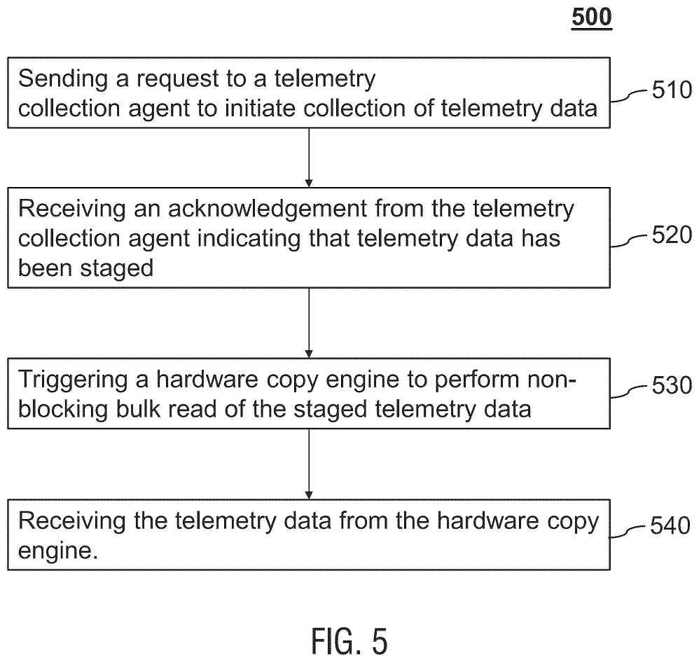

FIG. 5 illustrates a flowchart of an example of a method 500 for managing telemetry collection. The method 500 for managing telemetry collection may, for instance, be performed by an apparatus as described herein, such as apparatus 300 and/or apparatus 400. The method 500 comprises sending 510 a request to a telemetry collection agent to initiate collection of telemetry data from one or more memory devices of a plurality of memory devices managed by one or more memory controllers. The method 500 further comprises receiving 520 an acknowledgement from the telemetry collection agent indicating that telemetry data has been staged and is available for a non-blocking bulk read operation. The method 500 further comprises, in response to the acknowledgement, triggering 530 hardware copy engine to perform the non-blocking bulk read of the staged telemetry data from the telemetry collection agent. The method 500 further comprises receiving 540 the telemetry data from the hardware copy engine.

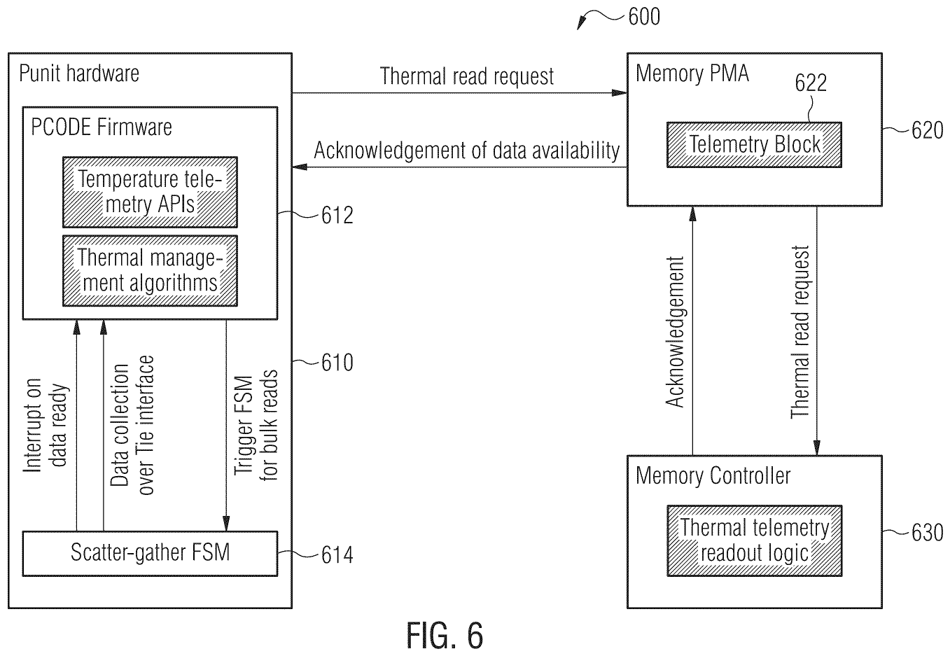

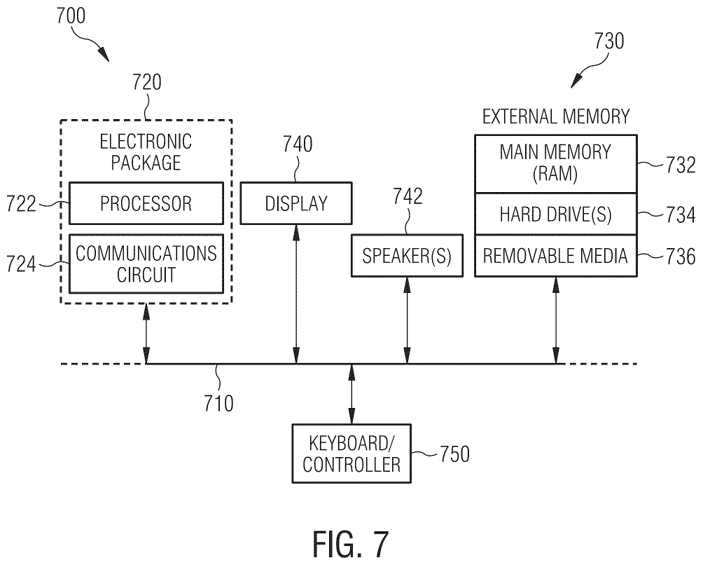

Further details and aspects are mentioned in connection with the examples described above or below. The example shown in FIG. 5 may include one or more optional additional features corresponding to one or more aspects mentioned in connection with the proposed concept or one or more examples described above (e.g., FIGS. 1-4) or below (e.g., FIGS. 6-7).

For example, in graphics processing unit (GPU) devices, memory device temperature and other telemetry collection may be important for several System-on-Chip (SoC) hardware and firmware algorithms to consume. The telemetry collection may also be important for telemetry reporting to software. Many memory controllers may provide a way to collect device telemetry via a request-acknowledgement protocol. Many memory controllers may provide a way to collect device telemetry via a direct control register read over a fabric. In each method, there may be a latency associated with the collection. The latency may vary depending on the method used. The latency may vary depending on logic block placement. In GPU and other products where memory requirements are higher, with increasing numbers of memory devices, it may be crucial for the SoC to collect telemetry information from all devices with minimal latency impact. For critical events such as thermal events in the SoC, timely action may be important. The systems and methods described for example in FIGS. 1 to 6 may provide a scalable and fast way to collect information without impacting other critical or periodic tasks.

For example, in GPUs or server and datacenter products, temperature and other memory telemetry from large numbers of memory devices may need to be collected. Latency to access memory device information may often be large. Access may require handshaking through a memory controller. If the system is violating a thermal constraint, it may be a critical event. A thermal constraint violation may occur when maximum memory device temperature exceeds a defined limit. Critical events may require fast handling within nanoseconds to a few microseconds. With such quality of service (QoS) requirements, it may be critical that periodic average or maximum temperature from all devices is published at predefined intervals. Firmware may need to avoid spending excessive time reading all devices. If firmware telemetry collection algorithms are slow, the system may not be able to respond to temperature variations fast enough. Slow response may result in catastrophic shutdown. Slow response may result in damage to components in worst cases. Slow response may result in unnecessary aggressive throttling that compromises performance.

In some examples, previous approaches to telemetry collection may have presented challenges. In previous generations, firmware may have been required to read registers in memory controllers over a sideband fabric to collect telemetry. A basic requirement from memory controller implementations may have been for firmware to send a request to the memory controller to initiate reads from memory devices. Firmware, once notified of data availability, may have needed to retrieve the data from the memory controller. The firmware may have requested the memory controller for temperature reads for a set of devices at a time. The memory controller hardware block may have initiated reads. The memory controller may have waited for thermal sensor reads to be completed. The memory controller may have sent an acknowledgement to the firmware. The firmware may then have been required to retrieve temperature data for the requested set from memory controller registers over the sideband fabric. This approach may have resulted in longer latency. Reading many devices may have added to the overall latency.

In some examples, the firmware may have periodically read a small set of registers at a time. The firmware may have allowed other tasks to be executed in between reads. The firmware may have kept track of how many registers had been read so far. This approach may have required managing atomic tasks with a small set of registers to read. This approach may have involved overhead of tracking the number of registers read. Once all sensor values were collected, the firmware may have aggregated and published minimum, maximum, and average values in telemetry. The firmware may have consumed the values in internal algorithms to manage temperature within system limits. The firmware may have published aggregated telemetry every period with previously read values for sensors until their latest temperature was read in a round-robin fashion. Firmware reading registers over the sideband fabric may have resulted in accumulated latency with a greater number of devices. This previous solution may have been a multi-step process which took longer to complete the full task.

Previous approaches may have presented several limitations. The registers in memory controllers may have changed with different memory configurations or different memory vendors. This requirement may have necessitated firmware changes from project to project. The method may have changed with every project when memory configuration and type changed. Previous approaches may not have scaled easily with increasing numbers of devices. Previous approaches may have required non-preemptive firmware kernels to manage atomic tasks. If proper care was not taken in managing atomic tasks, telemetry publishing may have caused quality of service violations in the system. Quality of service violations may have caused stability problems. Previous approaches may have risked the system not being able to react to temperature violations fast enough. The legacy approach may have been less efficient than the herein disclosed systems due to the sequential nature of register reads and the overhead of firmware management of the reading process.

FIG. 6 illustrates an example of a system 600 for facilitating and managing telemetry data collection. The system 600 comprises a power management unit (Punit) hardware 610 (for example apparatus 300), a Memory Power Management Agent (PMA) 620 (for example apparatus 100), and a Memory Controller 630. The system 600 may be a telemetry collection architecture for collecting telemetry data from memory devices in a computing platform. In some examples, the system 600 may be implemented within a System-on-Chip (SoC). The number of memory devices requiring telemetry data access may have increased in computing platforms, requiring improvement in telemetry data collection from memory.

The Punit hardware 610 may comprise power management firmware and hardware components. The Punit hardware 610 may correspond to the apparatus 300 as described with reference to FIG. 3. The Punit hardware 610 may be a management component configured to manage operational aspects of the computing platform. The Punit hardware 610 may comprise PCODE Firmware 612. The PCODE Firmware 612 may be firmware executing on processing circuitry within the Punit hardware 610. The PCODE Firmware 612 may comprise a Temperature telemetry collection Application Programming Interface (API). The Temperature telemetry collection API may provide functions for initiating and managing telemetry collection operations. The Punit hardware 610 may further comprise a Thermal management algorithms block. The Thermal management algorithms block may implement control algorithms for adjusting system operational parameters based on received telemetry data. The Punit hardware 610 may comprise a scatter-gather Finite State Machine (FSM) 614. The scatter-gather FSM 614 may be a hardware copy engine configured to perform non-blocking bulk read operations. The power management hardware may include the scatter-gather FSM 614. The scatter-gather FSM 614 may allow firmware to request reads of a range of register addresses.

In some example, the Memory PMA 620 may correspond to the apparatus 100 as described with reference to FIG. 1. The Memory PMA 620 may serve as a telemetry collection agent. The Memory PMA 620 may be integrated within the SoC. The Memory PMA 620 may be a hardware logic block. The Memory PMA 620 may be configured to execute a sequence of simple tasks. The Memory PMA 620 may be programmable, scalable, and maintainable. The Memory PMA 620 may be configured to interface and integrate with memory controllers. The Memory PMA 620 may comprise a Telemetry Block 622. The Telemetry Block 622 may comprise processing circuitry and local storage for staging telemetry data. The Telemetry Block 622 may receive requests from the Punit hardware 610. The Telemetry Block 622 may send commands to the Memory Controller 630. The Telemetry Block 622 may stage telemetry data into local storage. The Memory PMA 620 may be commanded by firmware to initiate thermal reads. The firmware may perform other tasks while the Memory PMA 620 interfacing with the Memory Controller 630 is collecting device telemetry.

The Memory Controller 630 may be a hardware component configured to manage access to one or more memory devices. The Memory Controller 630 may comprise a thermal telemetry readout logic block. The thermal telemetry readout logic block may be configured to read telemetry data from individual memory devices. The thermal telemetry readout logic block may initiate reads from memory devices in response to commands from the Memory PMA 620. Temperature data or other telemetry data may be stored in registers in the Memory Controller 630. Once data is available in the Memory Controller 630 registers, the firmware may collect all telemetry by using the scatter-gather FSM 614 instead of reading one by one over a sideband fabric. The system 600 may abstract device or memory controller-specific access topology at the Memory PMA 620 level. The system 600 may maintain a uniform interface between firmware and the Memory PMA 620. The uniform interface may provide a scalable, simpler, and faster way to collect temperature telemetry.

The system 600 may operate according to a telemetry collection flow. The PCODE Firmware 612 may periodically initiate a request to the Memory PMA 620 to start temperature reads. The periodic requests may occur at intervals of approximately one to two milliseconds. The request may be transmitted from the Punit hardware 610 to the Memory PMA 620 as indicated by arrow labeled “thermal read request” between the Punit hardware 610 and the Memory PMA 620. The Memory PMA 620 may forward the request to the Memory Controller 630. The forwarding may be indicated by arrow labeled “command to initiate reads” from the Memory PMA 620 to the Memory Controller 630. The Memory Controller 630 may initiate reads from individual memory devices managed by the Memory Controller 630. The temperature data may be stored in registers in the Memory Controller 630.

Once all devices'temperature data is collected, the Memory Controller 630 may send an acknowledgement to the Memory PMA 620 that the task has completed. The acknowledgement may be indicated by arrow labeled “acknowledgement and data” from the Memory Controller 630 to the Memory PMA 620. The Memory PMA 620 may copy data from the Memory Controller 630 registers to registers in the Memory PMA 620. The Memory PMA 620 may stage the telemetry data into local storage. The Memory PMA 620 may then send an acknowledgement to the PCODE Firmware 612 that data is available. The acknowledgement may be indicated by arrow labeled “Acknowledgement of data availability” from the Memory PMA 620 to the Punit hardware 610.

The PCODE Firmware 612 may then initiate a request to the scatter-gather FSM 614 to perform reads from a range of register addresses in the Memory PMA 620. This task may be non-blocking. The non-blocking nature may allow the PCODE Firmware 612 to perform other tasks while the scatter-gather FSM 614 performs the read operation. The request to the scatter-gather FSM 614 may be indicated by arrow labeled “Interrupt on data ready” and “Trigger bulk copy” between components within the Punit hardware 610. The scatter-gather FSM 614 may read the staged telemetry data from the registers of the Memory PMA 620. The read operation may be indicated by arrow labeled “Range bulk read” from the Punit hardware 610 to the Memory PMA 620.

The scatter-gather FSM 614 may send an interrupt to the PCODE Firmware 612 when data is available. The interrupt may notify the firmware that the bulk read operation has completed. The PCODE Firmware 612 may collect the telemetry data. The PCODE Firmware 612 may perform necessary operations to publish the telemetry or consume the telemetry data internally. The Thermal management algorithms block may use the telemetry data to adjust system operational parameters.

The system 600 may reduce latency. The scatter-gather FSM 614 may perform reads from the Memory PMA 620 registers instead of firmware reading from the Memory PMA 620 or Memory Controller 630 registers. The Memory PMA 620 may be located closer to the Punit hardware 610 than the Memory Controller 630. The proximity may allow for faster reads. The system 600 may provide low maintenance. The Memory PMA 620 may abstract memory access topology. The Memory PMA 620 may provide a uniform register interface for firmware to read. The uniform interface may not need to change from project to project due to memory type or configuration changes. The system 600 may provide scalability. The system 600 may easily scale with more or fewer numbers of devices. The system 600 may be used for any type of telemetry collection and may not be limited to temperature telemetry. The system 600 may provide simplification. The system 600 may simplify firmware tasks by allowing common APIs to access any telemetry.

Further details and aspects are mentioned in connection with the examples described above or below. The example shown in FIG. 6 may include one or more optional additional features corresponding to one or more aspects mentioned in connection with the proposed concept or one or more examples described above (e.g., FIGS. 1-5) or below (e.g., FIG. 7).

FIG. 7 illustrates an example of a block diagram of an electronic apparatus 700 incorporating at least one electronic assembly 100, 300 and/or 400 and/or method 200 and/or 500 described herein. Electronic apparatus 700 is merely one example of an electronic apparatus in which forms of the electronic assemblies 100, 300 and/or 400 and/or method 200 and/or 500 described herein may be used. Examples of an electronic apparatus 700 include, but are not limited to, personal computers, tablet computers, mobile telephones, game devices, MP3 or other digital music players, etc. In this example, electronic apparatus 700 comprises a data processing system that includes a system bus 710 to couple the various components of the electronic apparatus 700. System bus 710 provides communications links among the various components of the electronic apparatus 700 and may be implemented as a single bus, as a combination of busses, or in any other suitable manner.

An electronic assembly 720 as describe herein may be coupled to system bus 710. The electronic assembly 720 may include any circuit or combination of circuits. In one embodiment, the electronic assembly 720 includes a processor 722 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 720 are a custom circuit, an application-specific integrated circuit (ASIC), or the like, such as, for example, one or more circuits (such as a communications circuit 724) for use in wireless devices like mobile telephones, tablet computers, laptop computers, two-way radios, and similar electronic systems. The IC can perform any other type of function.

The electronic apparatus 700 may also include an external memory 730, which in turn may include one or more memory elements suitable to the particular application, such as a main memory 732 in the form of random access memory (RAM), one or more hard drives 734, and/or one or more drives that handle removable media 736 such as compact disks (CD), flash memory cards, digital video disk (DVD), and the like.

The electronic apparatus 700 may also include a display device 740, one or more speakers 742, and a keyboard and/or controller 750, which can include a mouse, trackball, touch screen, voice—recognition device, or any other device that permits a system user to input information into and receive information from the electronic apparatus 700.

Further details and aspects are mentioned in connection with the examples described above. The example shown in FIG. 7 may include one or more optional additional features corresponding to one or more aspects mentioned in connection with the proposed concept or one or more examples described above (e.g., FIGS. 1-6).

In the following, some examples of the proposed concept are presented:

An example (e.g., example 1) relates to an apparatus comprising interface circuitry configured to communicate with one or more memory controllers, and the apparatus further comprising machine-readable instructions and processing circuitry to execute the machine-readable instructions to receive a request from a management component to initiate collection of telemetry data from one or more memory devices of a plurality of memory devices managed by the one or more memory controllers, in response to the request, send a command to at least one of the one or more memory controllers to cause the at least one memory controller to read the telemetry data from one or more memory devices, receive the telemetry data from the at least one memory controller, stage the telemetry data into local storage of the apparatus, and send an acknowledgement to the management component indicating that the staged telemetry data is available for a non-blocking bulk read operation by a hardware copy engine.

Another example (e.g., example 2) relates to a previous example (e.g., example 1) or to any other example, further comprising that the telemetry data comprises at least one of temperature data, memory bandwidth data, energy consumption data, or operating frequency data.

Another example (e.g., example 3) relates to a previous example (e.g., one of the examples 1 to 2) or to any other example, further comprising that the processing circuitry is further to execute the machine-readable instructions to provide a uniform interface to the management component.

Another example (e.g., example 4) relates to a previous example (e.g., one of the examples 1 to 3) or to any other example, further comprising that the processing circuitry is further to execute the machine-readable instructions to translate the request received from the management component into a memory controller-specific command format required by the at least one of the one or more memory controllers, and organizing the telemetry data received from the at least one memory controller into a predefined layout within the local storage.

Another example (e.g., example 5) relates to a previous example (e.g., one of the examples 1 to 4) or to any other example, further comprising that the processing circuitry comprises a sequencer circuitry configured to execute the receiving of the request, the sending of the command, and the staging of the telemetry data.

Another example (e.g., example 6) relates to a previous example (e.g., one of the examples 1 to 5) or to any other example, further comprising that the local storage comprises one or more registers organized as a contiguous, addressable range to facilitate the non-blocking bulk read operation by the hardware copy engine.

Another example (e.g., example 7) relates to a previous example (e.g., one of the examples 1 to 6) or to any other example, further comprising the local storage, the local storage comprising one or more registers organized as a contiguous, addressable range to facilitate the non-blocking bulk read operation by the hardware copy engine.

Another example (e.g., example 8) relates to a previous example (e.g., one of the examples 1 to 7) or to any other example, further comprising that the request from the management component is received on a periodic basis.

Another example (e.g., example 9) relates to a previous example (e.g., one of the examples 1 to 8) or to any other example, further comprising that the management component is configured to manage one or more operational aspects of a platform that comprises the apparatus

Another example (e.g., example 10) relates to a previous example (e.g., one of the examples 1 to 9) or to any other example, further comprising that the hardware copy engine is a scatter-gather finite state machine, FSM.

Another example (e.g., example 11) relates to a previous example (e.g., example 10) or to any other example, further comprising that the scatter-gather FSM is configured to copy the staged telemetry data from the one or more registers of the apparatus to a storage location accessible by the management component.

An example (e.g., example 12) relates to an apparatus comprising interface circuitry, machine-readable instructions and processing circuitry to execute the machine-readable instructions to send a request to a telemetry collection agent to initiate collection of telemetry data from one or more memory devices of a plurality of memory devices managed by one or more memory controllers, receive an acknowledgement from the telemetry collection agent indicating that telemetry data has been staged and is available for a non-blocking bulk read operation, in response to the acknowledgement, trigger a hardware copy engine to perform the non-blocking bulk read of the staged telemetry data from the telemetry collection agent, and receive the telemetry data from the hardware copy engine.

Another example (e.g., example 13) relates to a previous example (e.g., example 12) or to any other example, further comprising that the processing circuitry is further to execute the machine-readable instructions to send the request on a periodic basis.

Another example (e.g., example 14) relates to a previous example (e.g., one of the examples 12 to 13) or to any other example, further comprising the hardware copy engine.

Another example (e.g., example 15) relates to a previous example (e.g., one of the examples 12 to 14) or to any other example, further comprising that the hardware copy engine is a scatter-gather finite state machine FSM.

Another example (e.g., example 16) relates to a previous example (e.g., one of the examples 12 to 15) or to any other example, further comprising that the telemetry data comprises at least one of temperature data, memory bandwidth data, energy consumption data, or operating frequency data.

Another example (e.g., example 17) relates to a previous example (e.g., one of the examples 12 to 15) or to any other example, further comprising that the processing circuitry is further to execute the machine-readable instructions to adjust a system operational parameter based on the received telemetry data.

Another example (e.g., example 18) relates to a previous example (e.g., example 17) or to any other example, further comprising that the telemetry data comprises the temperature data, and wherein the system operational parameter is a thermal management parameter comprising at least one of a clock frequency, a fan speed, or a power budget.

Another example (e.g., example 19) relates to a previous example (e.g., one of the examples 17 to 18) or to any other example, further comprising that the telemetry data comprises at least one of the memory bandwidth data or the energy consumption data, and wherein the system operational parameter is a performance management parameter comprising at least one of a clock frequency, a power state, or a voltage level.

An example (e.g., example 20) relates to a method comprising receiving a request from a management component to initiate collection of telemetry data from one or more memory devices of a plurality of memory devices managed by one or more memory controllers, in response to the request, sending a command to at least one of the one or more memory controllers to cause the at least one memory controller to read the telemetry data from one or more memory devices, receiving the telemetry data from the at least one memory controller, staging the telemetry data into local storage, and sending an acknowledgement to the management component indicating that the staged telemetry data is available for a non-blocking bulk read operation by a hardware copy engine.

Another example (e.g., example 21) relates to a previous example (e.g., example 20) or to any other example, further comprising that the telemetry data comprises at least one of temperature data, memory bandwidth data, energy consumption data, or operating frequency data.

Another example (e.g., example 22) relates to a previous example (e.g., one of the examples 20 to 21) or to any other example, further comprising providing a uniform interface to the management component.

Another example (e.g., example 23) relates to a previous example (e.g., one of the examples 20 to 22) or to any other example, further comprising translating the request received from the management component into a memory controller-specific command format required by the at least one of the one or more memory controllers, and organizing the telemetry data received from the at least one memory controller into a predefined layout within the local storage.

Another example (e.g., example 24) relates to a previous example (e.g., one of the examples 20 to 23) or to any other example, further comprising that the receiving of the request, the sending of the command, and the staging of the telemetry data are executed by sequencer circuitry.

Another example (e.g., example 25) relates to a previous example (e.g., one of the examples 20 to 24) or to any other example, further comprising that the local storage comprises one or more registers organized as a contiguous, addressable range to facilitate the non-blocking bulk read operation by the hardware copy engine.

Another example (e.g., example 26) relates to a previous example (e.g., one of the examples 20 to 25) or to any other example, further comprising that the request from the management component is received on a periodic basis.

Another example (e.g., example 27) relates to a previous example (e.g., one of the examples 20 to 26) or to any other example, further comprising that the management component is configured to manage one or more operational aspects of a platform.

Another example (e.g., example 28) relates to a previous example (e.g., one of the examples 20 to 27) or to any other example, further comprising that the hardware copy engine is a scatter-gather finite state machine, FSM.

1Another example (e.g., example 29) relates to a previous example (e.g., example 28) or to any other example, further comprising that the scatter-gather FSM is configured to copy the staged telemetry data from the one or more registers to a storage location accessible by the management component.

An example (e.g., example 30) relates to a non-transitory computer-readable medium storing instructions that, when executed by one or more processing circuitries, causing the one or more processing circuitries to perform a method comprising receiving a request from a management component to initiate collection of telemetry data from one or more memory devices of a plurality of memory devices managed by one or more memory controllers, in response to the request, sending a command to at least one of the one or more memory controllers to cause the at least one memory controller to read the telemetry data from one or more memory devices, receiving the telemetry data from the at least one memory controller, staging the telemetry data into local storage, and sending an acknowledgement to the management component indicating that the staged telemetry data is available for a non-blocking bulk read operation by a hardware copy engine.

Another example (e.g., example 31) relates to a previous example (e.g., example 30) or to any other example, further comprising that the telemetry data comprises at least one of temperature data, memory bandwidth data, energy consumption data, or operating frequency data.

Another example (e.g., example 32) relates to a previous example (e.g., one of the examples 30 to 31) or to any other example, further comprising that the method further comprises providing a uniform interface to the management component.

Another example (e.g., example 33) relates to a previous example (e.g., one of the examples 30 to 32) or to any other example, further comprising that the method further comprises translating the request received from the management component into a memory controller-specific command format required by the at least one of the one or more memory controllers, and organizing the telemetry data received from the at least one memory controller into a predefined layout within the local storage.

Another example (e.g., example 34) relates to a previous example (e.g., one of the examples 30 to 33) or to any other example, further comprising that the receiving of the request, the sending of the command, and the staging of the telemetry data are executed by sequencer circuitry.

Another example (e.g., example 35) relates to a previous example (e.g., one of the examples 30 to 34) or to any other example, further comprising that the local storage comprises one or more registers organized as a contiguous, addressable range to facilitate the non-blocking bulk read operation by the hardware copy engine.

Another example (e.g., example 36) relates to a previous example (e.g., one of the examples 30 to 35) or to any other example, further comprising that the request from the management component is received on a periodic basis.

Another example (e.g., example 37) relates to a previous example (e.g., one of the examples 30 to 36) or to any other example, further comprising that the management component is configured to manage one or more operational aspects of a platform.

Another example (e.g., example 38) relates to a previous example (e.g., one of the examples 30 to 37) or to any other example, further comprising that the hardware copy engine is a scatter-gather finite state machine, FSM.

Another example (e.g., example 39) relates to a previous example (e.g., example 38) or to any other example, further comprising that the scatter-gather FSM is configured to copy the staged telemetry data from the one or more registers to a storage location accessible by the management component.

An example (e.g., example 40) relates to an apparatus comprising a processor circuitry configured to receive a request from a management component to initiate collection of telemetry data from one or more memory devices of a plurality of memory devices managed by the one or more memory controllers, in response to the request, send a command to at least one of the one or more memory controllers to cause the at least one memory controller to read the telemetry data from one or more memory devices, receive the telemetry data from the at least one memory controller, stage the telemetry data into local storage of the apparatus, and send an acknowledgement to the management component indicating that the staged telemetry data is available for a non-blocking bulk read operation by a hardware copy engine.

An example (e.g., example 41) relates to a device comprising means for processing for receiving a request from a management component to initiate collection of telemetry data from one or more memory devices of a plurality of memory devices managed by one or more memory controllers, in response to the request, sending a command to at least one of the one or more memory controllers to cause the at least one memory controller to read the telemetry data from one or more memory devices, receiving the telemetry data from the at least one memory controller, staging the telemetry data into local storage, and sending an acknowledgement to the management component indicating that the staged telemetry data is available for a non-blocking bulk read operation by a hardware copy engine.

Another example (e.g., example 42) relates to a computer program having a program code for performing the method of any one of examples 20 to 29 when the computer program is executed on a computer, a processor, or a programmable hardware component.

An example (e.g., example 43) relates to a method comprising sending a request to a telemetry collection agent to initiate collection of telemetry data from one or more memory devices of a plurality of memory devices managed by one or more memory controllers, receiving an acknowledgement from the telemetry collection agent indicating that telemetry data has been staged and is available for a non-blocking bulk read operation, in response to the acknowledgement, triggering a hardware copy engine to perform the non-blocking bulk read of the staged telemetry data from the telemetry collection agent, and receiving the telemetry data from the hardware copy engine.

Another example (e.g., example 44) relates to a previous example (e.g., example 43) or to any other example, further comprising sending the request on a periodic basis.

Another example (e.g., example 45) relates to a previous example (e.g., one of the examples 43 to 44) or to any other example, further comprising that the hardware copy engine is a scatter-gather finite state machine FSM.

Another example (e.g., example 46) relates to a previous example (e.g., one of the examples 43 to 45) or to any other example, further comprising that the telemetry data comprises at least one of temperature data, memory bandwidth data, energy consumption data, or operating frequency data.

Another example (e.g., example 47) relates to a previous example (e.g., one of the examples 43 to 45) or to any other example, further comprising adjusting a system operational parameter based on the received telemetry data.

Another example (e.g., example 48) relates to a previous example (e.g., example 47) or to any other example, further comprising that the telemetry data comprises the temperature data, and wherein the system operational parameter is a thermal management parameter comprising at least one of a clock frequency, a fan speed, or a power budget.

Another example (e.g., example 49) relates to a previous example (e.g., one of the examples 47 to 48) or to any other example, further comprising that the telemetry data comprises at least one of the memory bandwidth data or the energy consumption data, and wherein the system operational parameter is a performance management parameter comprising at least one of a clock frequency, a power state, or a voltage level.

An example (e.g., example 50) relates to a non-transitory computer-readable medium storing instructions that, when executed by one or more processing circuitries, causing the one or more processing circuitries to perform a method comprising sending a request to a telemetry collection agent to initiate collection of telemetry data from one or more memory devices of a plurality of memory devices managed by one or more memory controllers, receiving an acknowledgement from the telemetry collection agent indicating that telemetry data has been staged and is available for a non-blocking bulk read operation, in response to the acknowledgement, triggering a hardware copy engine to perform the non-blocking bulk read of the staged telemetry data from the telemetry collection agent, and receiving the telemetry data from the hardware copy engine.

Another example (e.g., example 51) relates to a previous example (e.g., example 50) or to any other example, further comprising that the method further comprises sending the request on a periodic basis.

Another example (e.g., example 52) relates to a previous example (e.g., one of the examples 50 to 51) or to any other example, further comprising that the hardware copy engine is a scatter-gather finite state machine FSM.

Another example (e.g., example 53) relates to a previous example (e.g., one of the examples 50 to 52) or to any other example, further comprising that the telemetry data comprises at least one of temperature data, memory bandwidth data, energy consumption data, or operating frequency data.

Another example (e.g., example 54) relates to a previous example (e.g., one of the examples 50 to 52) or to any other example, further comprising that the method further comprises adjusting a system operational parameter based on the received telemetry data.

Another example (e.g., example 55) relates to a previous example (e.g., example 54) or to any other example, further comprising that the telemetry data comprises the temperature data, and wherein the system operational parameter is a thermal management parameter comprising at least one of a clock frequency, a fan speed, or a power budget.

Another example (e.g., example 56) relates to a previous example (e.g., one of the examples 54 to 55) or to any other example, further comprising that the telemetry data comprises at least one of the memory bandwidth data or the energy consumption data, and wherein the system operational parameter is a performance management parameter comprising at least one of a clock frequency, a power state, or a voltage level.

An example (e.g., example 57) relates to an apparatus comprising a processor circuitry configured to send a request to a telemetry collection agent to initiate collection of telemetry data from one or more memory devices of a plurality of memory devices managed by one or more memory controllers, receive an acknowledgement from the telemetry collection agent indicating that telemetry data has been staged and is available for a non-blocking bulk read operation, in response to the acknowledgement, trigger a hardware copy engine to perform the non-blocking bulk read of the staged telemetry data from the telemetry collection agent, and receive the telemetry data from the hardware copy engine.

An example (e.g., example 58) relates to a device comprising means for processing for sending a request to a telemetry collection agent to initiate collection of telemetry data from one or more memory devices of a plurality of memory devices managed by one or more memory controllers, receiving an acknowledgement from the telemetry collection agent indicating that telemetry data has been staged and is available for a non-blocking bulk read operation, in response to the acknowledgement, triggering a hardware copy engine to perform the non-blocking bulk read of the staged telemetry data from the telemetry collection agent, and receiving the telemetry data from the hardware copy engine.

Another example (e.g., example 59) relates to a computer program having a program code for performing the method of any one of examples 43 to 49 when the computer program is executed on a computer, a processor, or a programmable hardware component.

Another example (e.g., example 60) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising:
interface circuitry configured to communicate with one or more memory controllers; and
the apparatus further comprising machine-readable instructions and processing circuitry to execute the machine-readable instructions to:
receive a request from a management component to initiate collection of telemetry data from one or more memory devices of a plurality of memory devices managed by the one or more memory controllers;
in response to the request, send a command to at least one of the one or more memory controllers to cause the at least one memory controller to read the telemetry data from one or more memory devices;
receive the telemetry data from the at least one memory controller;
stage the telemetry data into local storage of the apparatus; and
send an acknowledgement to the management component indicating that the staged telemetry data is available for a non-blocking bulk read operation by a hardware copy engine.

2. The apparatus of claim 1, wherein the telemetry data comprises at least one of temperature data, memory bandwidth data, energy consumption data, or operating frequency data.

3. The apparatus of claim 1, wherein the processing circuitry is further to execute the machine-readable instructions to provide a uniform interface to the management component.

4. The apparatus of claim 1, wherein the processing circuitry is further to execute the machine-readable instructions to translate the request received from the management component into a memory controller-specific command format required by the at least one of the one or more memory controllers; and
organizing the telemetry data received from the at least one memory controller into a predefined layout within the local storage.

5. The apparatus of claim 1, wherein the processing circuitry comprises a sequencer circuitry configured to execute the receiving of the request, the sending of the command, and the staging of the telemetry data.

6. The apparatus of claim 1, wherein the local storage comprises one or more registers organized as a contiguous, addressable range to facilitate the non-blocking bulk read operation by the hardware copy engine.

7. The apparatus of claim 1, further comprising the local storage, the local storage comprising one or more registers organized as a contiguous, addressable range to facilitate the non-blocking bulk read operation by the hardware copy engine.

8. The apparatus of claim 1, wherein the request from the management component is received on a periodic basis.

9. The apparatus of claim 1, wherein the management component is configured to manage one or more operational aspects of a platform that comprises the apparatus.

10. The apparatus of claim 1, wherein the hardware copy engine is a scatter-gather finite state machine, FSM.

11. The apparatus of claim 10, wherein the scatter-gather FSM is configured to copy the staged telemetry data from the one or more registers of the apparatus to a storage location accessible by the management component.

12. An apparatus comprising interface circuitry, machine-readable instructions and processing circuitry to execute the machine-readable instructions to:
send a request to a telemetry collection agent to initiate collection of telemetry data from one or more memory devices of a plurality of memory devices managed by one or more memory controllers;
receive an acknowledgement from the telemetry collection agent indicating that telemetry data has been staged and is available for a non-blocking bulk read operation;
in response to the acknowledgement, trigger a hardware copy engine to perform the non-blocking bulk read of the staged telemetry data from the telemetry collection agent; and
receive the telemetry data from the hardware copy engine.

13. The apparatus of claim 12, wherein the processing circuitry is further to execute the machine-readable instructions to send the request on a periodic basis.

14. The apparatus of claim 12, further comprising the hardware copy engine.

15. The apparatus of claim 12, wherein the hardware copy engine is a scatter-gather finite state machine FSM.

16. The apparatus of claim 12, wherein the telemetry data comprises at least one of temperature data, memory bandwidth data, energy consumption data, or operating frequency data.

17. The apparatus of claim 12, wherein the processing circuitry is further to execute the machine-readable instructions to adjust a system operational parameter based on the received telemetry data.

18. The apparatus of claim 17, wherein the telemetry data comprises the temperature data, and wherein the system operational parameter is a thermal management parameter comprising at least one of a clock frequency, a fan speed, or a power budget.

19. The apparatus of claim 17, wherein the telemetry data comprises at least one of the memory bandwidth data or the energy consumption data, and wherein the system operational parameter is a performance management parameter comprising at least one of a clock frequency, a power state, or a voltage level.

20. A non-transitory computer-readable medium storing instructions that, when executed by processing circuitry of a management component, cause the management component to:
sending a request to a telemetry collection agent to initiate collection of telemetry data from one or more memory devices of a plurality of memory devices managed by one or more memory controllers;
receiving an acknowledgement from the telemetry collection agent indicating that telemetry data has been staged and is available for a non-blocking bulk read operation;
in response to the acknowledgement, triggering hardware copy engine to perform the non-blocking bulk read of the staged telemetry data from the telemetry collection agent; and
receiving the telemetry data from the hardware copy engine.
